(19) United States
(12) Patent Application Publication
(10) Pub. No.: US 2026/0075179 A1
(43) Pub. Date: Mar. 12, 2026

(54) ROTATIONALLY SWITCHING BETWEEN CAMERAS TO PROVIDE STEREO VISION

(71) Applicant: QUALCOMM Incorporated, San Diego, CA (US)

(72) Inventor: Jamie Menjay LIN, San Diego, CA (US)

(21) Appl. No.: 19/285,273

(22) Filed: Jul. 30, 2025

Related U.S. Application Data
(60) Provisional application No. 63/693,581, filed on Sep. 11, 2024.

(51) Int. Cl. H04N 13/106; H04N 13/156; H04N 13/243

(52) U.S. Cl. CPC H04N 13/158; H04N 13/156; H04N 13/243

(57) ABSTRACT

Aspects relate to rotationally switching between cameras to provide stereo vision of an object. A device may include one or more memories configured to store one or more images including an object and a plurality of cameras. The plurality of cameras may be configured to capture the one or more images including the object. The device may further include one or more processors coupled to the one or memories, in which, the one or more processors are configured to: based upon an object detected, determine a subset of cameras from the plurality of cameras to provide stereo vision of the object; and rotationally switch between a previously selected subset of cameras for a previous object to the determined subset of cameras for the object to provide stereo vision of the object.

### CROSS-REFERENCE TO RELATED APPLICATIONS

The application claims priority to and the benefit of U.S. provisional patent application No. 63/693,581 filed on Sep. 11, 2024, the entire content of which is incorporated herein by reference as if fully set forth below in its entirety and for all applicable purposes.

### TECHNICAL FIELD

The technology discussed below relates generally to switching between cameras in a device, and more particularly, to rotationally switching between cameras in a device to provide stereo vision of an object.

### INTRODUCTION

Stereo vision may be defined as the ability to perceive depth and spatial information by using two images of the same scene from slightly different perspectives. It is based on the idea that humans have two eyes that see the world from slightly different positions, and the brain combines these views to create a three-dimensional sensation. Stereo video or pictures may be achieved using two views, e.g., a left view and a right view. In order to simulate a human vision system, which has depth perception, a device with two camera sensors may capture left eye and right eye views. In stereo vision, there is disparity in the distance between corresponding points in the two images taken from the slightly different positions of the two camera sensors having left and right views. A stereo image may be created by a device by combing the two images from the left and right camera sensors.

In many devices, various cameras are physically fixed at different locations in or on the device. Oftentimes, when a device captures an image with a pair of cameras, the device does not select the pair of cameras that provide the best stereo image.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a device is provided. The device may include one or more memories configured to store one or more images including an object. The device may further include a plurality of cameras configured to capture the one or more images including the object and one or more processors coupled to the one or memories. The one or more processors may be configured to: based upon an object detected, determine a subset of cameras from the plurality of cameras to provide stereo vision of the object; and rotationally switch between a previously selected subset of cameras for a previous object to the determined subset of cameras for the object to provide stereo vision of the object.

Another example is a method for providing stereo vision of an object. The method includes capturing one or more images including the object from a plurality of cameras. The method further includes: based upon an object detected, determine a subset of cameras from the plurality of cameras to provide stereo vision of the object; and rotationally switch between a previously selected subset of cameras for a previous object to the determined subset of cameras for the object to provide stereo vision of the object.

In yet another example, a non-transitory computer-readable data storage medium is provided that has stored thereon instructions that, when executed, cause one or more processors to: capture one or more images including an object from a plurality of cameras; based upon an object detected, determine a subset of cameras from the plurality of cameras to provide stereo vision of the object; and rotationally switch between a previously selected subset of cameras for a previous object to the determined subset of cameras for the object to provide stereo vision of the object.

These and other aspects will become more fully understood upon a review of the detailed description, which follows. Other aspects, features, and examples will become apparent to those of ordinary skill in the art, upon reviewing the following description of examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices.

### BRIEF DESCRIPTION OF THE DRAWINGS

FIG. 1 is a diagram illustrating an example of a device according to some aspects.

FIG. 2 is a diagram illustrating an example of cameras used in performing camera switching operations according to some aspects.

FIG. 3 is a diagram illustrating an example of cameras used in performing camera switching operations according to some aspects.

FIG. 4 is a diagram illustrating an example of cameras used in performing camera switching operations according to some aspects.

FIG. 5 is a diagram illustrating an example of vehicle with cameras used in performing camera switching operations according to some aspects.

FIG. 6 is a diagram illustrating an example of cameras used in performing camera switching operations and combining multiple subsets of cameras according to some aspects.

FIG. 7 is a flowchart describing performing camera switching operations according to some aspects.

FIG. 8 is a diagram illustrating an example of a device according to some aspects.

FIG. 9 is a diagram illustrating an example of vehicle with cameras used in performing camera switching operations according to some aspects.

FIG. 10 is a diagram illustrating an example of a device utilizing a semantic generator according to some aspects.

FIG. 11 is a diagram illustrating an example of a world point P (X,Y,Z), a left image plane of the left camera, and a right image plane of the right camera according to some aspects.

FIG. 12 is a diagram illustrating an example of disparities between pixels on the left and right image planes according to some aspects.

FIG. 13 is a flowchart illustrating an example operation for down-sampling according to some aspects.

FIG. 14 is a diagram illustrating an example operation for down-sampling images according to some aspects.

FIG. 15A is a diagram illustrating down-sampling utilizing multiple-aspect ratios according to some aspects.

FIG. 15B is a diagram illustrating down-sampling and up-sampling utilizing multiple-aspect ratios according to some aspects.

FIG. 16 is a diagram illustrating asymmetric S2D operations for down-sampling and asymmetric D2S for up-sampling according to some aspects.

FIG. 17 illustrates a proof-of-concept of the techniques of the disclosure related to encoding and decoding for stereo depth estimation utilizing asymmetric operations according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Aspect of the disclosure relate to rotationally switching between cameras to provide stereo vision of an object. In one aspect, a device rotationally switches between cameras to select a pair of cameras to provide the best stereo vision of an object. The device may include one or more processors, in which, the one or more processors are configured to: based upon a new object detected, determine a subset of cameras from the plurality of cameras to provide stereo vision of the new object; and rotationally switch between a previously selected subset of cameras for a previous object to the determined subset of cameras for the new object to provide stereo vision of the new object.

As will be described, by having multiple cameras and by providing multiple choices of stereo cameras, a device may select the most accurate stereo vision of an object. As will be described, a device utilizing stereo camera switching and switchable rectifications enables higher accuracy, consistency, diversity, and/or efficiency.

In one aspect, as will be described, the subset of cameras determined to provide stereo vision of the object, are determined to be the subset of cameras that provide the best stereo vision of the object. In one example aspect, a stereo sensor switching (SSS) technique, as will be described, automatically determines and switches to a selection of cameras out of available candidate cameras to support the best stereo vision of the object.

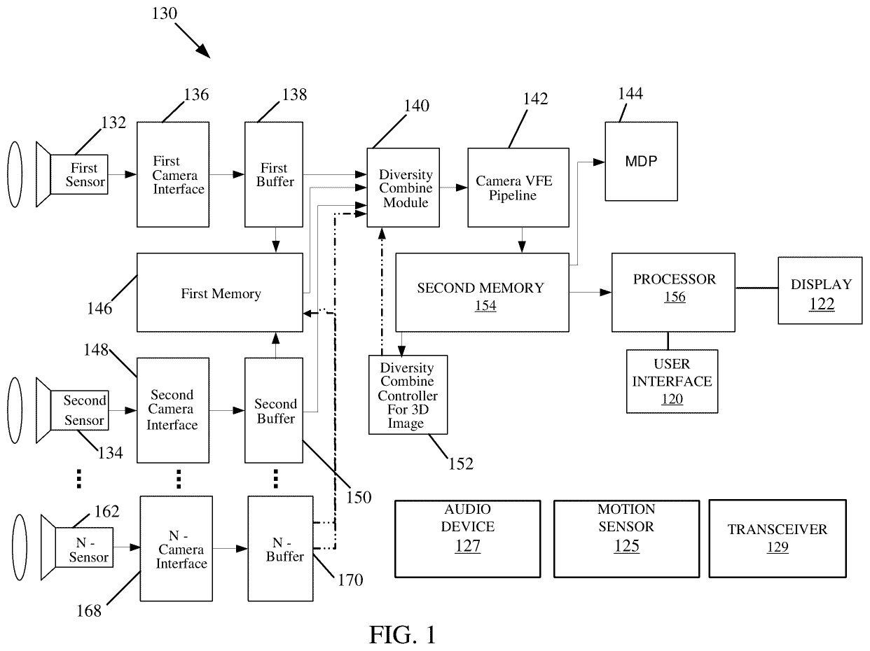

FIG. 1 illustrates a device 130 with multiple digital sensors (first, second. . . . N) 132, 134, 162 configured to capture and process 3-D stereo images and videos. It should be appreciated that digital sensors 132, 134, 162 may be camera sensors but that other sorts of sensors may be utilized. Also, device 130 may be a mobile device but also may be a fixed device or another sort of device. In general, device 130 may be configured to capture, create, process, modify, scale, encode, decode, transmit, store, and display digital images and/or video sequences. Device 130 may provide high-quality stereo image capturing, various sensor locations, view angle mismatch compensation, and an efficient solution to process and combine a stereo image.

In one aspect, device 130 may be: a mobile device, a mobile phone, a vehicle, a robot, a stationary Internet of Things (IoT) device, a mobile IoT device, or a security device. However, these devices are just examples and it should be appreciated that device 130 may be any suitable device.

Additionally device 130 may represent or be implemented in a wireless communication device, a personal digital assistant (PDA), a handheld device, a laptop computer, a desktop computer, a digital camera, a digital recording device, a network-enabled digital television, a mobile phone, a cellular phone, a satellite telephone, a camera phone, a terrestrial-based radiotelephone, a direct two-way communication device (sometimes referred to as a “walkie-talkie”), a camcorder, etc.

Device 130 may include a first camera sensor 132, a second camera sensor 134, a N-camera sensor 162, a first camera interface 136, a second camera interface 148, a N-camera interface 168, a first buffer 138, a second buffer 150, a N-buffer 170, a memory 146, a diversity combine module 140 (or engine), a camera process pipeline 142, a second memory 154, a diversity combine controller for 3-D image 152, a mobile display processor (MDP) 144, a processor 156, a user interface 120, a display device 122, a motion sensor 125, an audio device 127, and a transceiver or modem 129. It should be appreciated that motion sensor 125, audio device, and transceiver may also be coupled to processor 156. In addition to or instead of the components shown in FIG. 1, device 130 may include other components. The architecture in FIG. 1 is merely an example. The features and techniques described herein may be implemented with a variety of other architectures.

As will be described, device 130 may include utilize processor 156 to interact with a plurality of different cameras (N-cameras) (e.g., camera 1 132, camera 2, camera N 162), in which, processor 156 may determine a subset of cameras to provide the best stereo vision of an object. In one example aspect, processor 156 may be configured to implement operations including: based upon new object detected, determine a subset of cameras from the plurality of cameras (e.g., camera 1 132, camera 2, camera N 162) to provide stereo vision of the new object detected and automatically rotationally switch between the previously selected subset of cameras for a previous object to the determined new subset of cameras for the new object to provide stereo vision of the new object. Therefore, it should be appreciated that device 130 may include any number (N) of cameras.

The sensors 132, 134, 162 (N-sensors) may be digital camera sensors. The sensors 132, 134, 162 may have similar or different physical structures. The sensors 132, 134, 162 may have similar or different configured settings. The sensors 132, 134, 164 may capture still image snapshots and/or video sequences. Each sensor may include color filter arrays (CFAs) arranged on a surface of individual sensors or sensor elements.

The memories 146, 154 may be separate or integrated. The memories 146, 154 may store images or video sequences before and after processing. The memories 146, 154 may include volatile storage and/or non-volatile storage. The memories 146, 154 may comprise any type of data storage means, such as dynamic random access memory (DRAM), FLASH memory, NOR or NAND gate memory, or any other data storage technology.

The camera process pipeline 142 (also called engine, module, processing unit, video front end (VFE), etc.) may comprise a chip set for a mobile phone, which may include hardware, software, firmware, and/or one or more microprocessors, digital signal processors (DSPs), application specific integrated circuits (ASICs), field programmable gate arrays (FPGAs), or various combinations thereof. The pipeline 142 may perform one or more image processing techniques to improve quality of an image and/or video sequence.

Processor 156 may include one or more processors and may implement down-sampling/encoding functions and/or up-sampling/decoding functions. Processor 156 may also implement other functions of device 130. Processor 156 may operate as a video encoder and may implement or comprise an encoder/decoder (CODEC) for encoding (or down-sample or compress, etc.) and decoding (or up-sample or decompress) digital video data. As an example, the processor operating to implement video encoder function may use one or more encoding/decoding standards or formats, such as MPEG or H.264. In other examples, separate video encoder and/or video decoder devices may be utilized.

The transceiver or modem 129 may receive and/or transmit coded images or video sequences to another device or a network. The transceiver or modem 129 may use a wireless communication standard, such as code division multiple access (CDMA). Examples of CDMA standards include CDMA 1× Evolution Data Optimized (EV-DO) (3GPP2), Wideband CDMA (WCDMA) (3GPP), etc. In other examples, transceiver or modem 129 may utilize other cellular communication standards, such as 4G, 4G-LTE (Long-Term Evolution), LTE Advanced, 5G, 6G, or the like. In some examples, other wireless standards, such as IEEE 802.11 specification, IEEE 802.15 specification (e.g., ZigBee™), Bluetooth™ standard, or the like, may be utilized.

Device 130 may maintain a fixed horizontal distance between the sensors 132, 134, 162 such that 3-D stereo image and video can be generated efficiently. As shown in FIG. 1, the N-sensors 132, 134, 162 may be separated by a suitable fixed horizontal distance. The first sensor 132 may be a primary sensor, and the second sensor 134 and N-sensor 162 may be secondary sensors. The secondary sensors may be shut off for non-stereo mode to reduce power consumption. However, this is an optional sensor set-up.

The buffers 138, 150, 170 may store real time sensor input data, such as one row or line of pixel data from the sensors 132, 134, 162. Sensor pixel data may enter the small buffers 138, 150, 170 on-line (i.e., in real time) and be processed by the diversity combine module 140 and/or camera engine pipeline engine 142 offline with switching between the sensors 132, 134, 160 (or buffers 138, 150, 170) back and forth. The diversity combine module 140 and/or camera engine pipeline engine 142 may operate at about two times the speed of one sensor's data rate. To reduce output data bandwidth and memory requirement, stereo image and video may be composed in the camera engine 142.

The diversity combine module 140 may first select data from the first buffer 138. At the end of one row of buffer 138, the diversity combine module 140 may switch to the second buffer 150 to obtain data from the second sensor 134 or likewise to the N-buffer 170 to obtain data from the N-sensor 162. The diversity combine module 140 may switch back to the first buffer 138 at the end of one row of data from the second buffer 150 or N-buffer 170.

In order to reduce processing power and data traffic bandwidth, the sensor image data in video mode may be sent directly through the buffers 138, 150, 170 (bypassing the first memory 146) to the diversity combine module 140. On the other hand, for a snapshot (image) processing mode, the sensor data may be saved in the memory 146 for offline processing. In addition, for low power consumption profiles, the second sensor 134 or N-sensor 162 may be turned off, and the camera pipeline driven clock may be reduced.

Aspects of the disclosure relate to rotationally switching between cameras 132, 134, and 162 to provide stereo vision of an object. As previously described, device 130 may include one or more memories 146, 154 configured to store one or more images including an object and device 130 includes a plurality of cameras (first camera 132, second camera 134, and Nth camera 162). The plurality of cameras may be configured to capture the one or more images including the object. The device 130 may further include one or more processors 156 coupled to the one or memories. Processor 156 may be configured to: based upon a new object detected, determine a subset of cameras from the plurality of cameras 132, 134, and 162 to provide stereo vision of the new object; and rotationally switch between a previously selected subset of cameras for a previous object to the determined subset of cameras for the new object to provide stereo vision of the new object.

In one example, device 130 may include processor 156 to interact with the plurality of different cameras (N-cameras) (e.g., camera 1 132, camera 2 134, camera N 162), in which, processor 156 may determine a subset of cameras to provide a best stereo vision of the object. In one example aspect, processor 156 may be configured to implement operations including: based upon a new object detected, determine a subset of cameras from the plurality of cameras (e.g., camera 1 132, camera 2 134, camera N 162) to provide stereo vision of the new object detected and automatically rotationally switch between the previously selected subset of cameras for a previous object to the determined new subset of cameras for the new object to provide stereo vision of the new object.

In one aspect, as will be described, the subset of cameras determined to provide stereo vision of the object, are determined to be the subset of cameras that provide the best stereo vision of the object. In one example aspect, a stereo sensor switching (SSS) technique, as will be described, automatically determines and switches for the best selection of cameras out of available candidate cameras to support optimal stereo vision of an object.

Therefore, by having multiple cameras and by providing multiple choices of stereo cameras, device 130 may select the most accurate stereo vision of an object. As will be described, a device utilizing stereo camera switching and switchable rectifications enables higher accuracy, consistency, diversity, and/or efficiency.

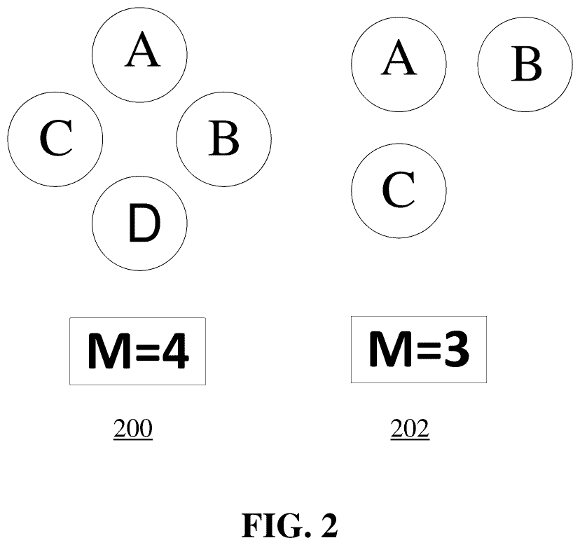

With additional reference to FIG. 2, an example of stereo sensor switching (SSS) will be described. FIG. 2 provides an example of: four cameras 200 (M=4)−e.g., camera A, camera B, camera C, and camera D; and three cameras 202 (M=3)−e.g., camera A, camera B, and camera C; either of which may be available on device 130. These cameras may be equivalent to camera 1 132 (camera A), camera 2 134 (camera B), and cameras N 162 (e.g., cameras C and D) in FIG. 1.

In the stereo sensor switching (SSS) technique, device 130 under control of processor 156 automatically determines and switches for the best selection of stereo cameras out of available candidate cameras to support stereo vision. As an example, given a set of M available cameras, the SSS technique determines and switches to the optimal set of N (N≤M) cameras at time t that best jointly handle stereo vision and/or geometric estimation in terms of estimation and imaging accuracy, image quality, directional high-frequency components, and/or efficiency for stereo rectification, stereo depth, stereo geometry, and/or stereo imaging. It should be noted that due to the rectification assumption for stereo vision processing, given the targeted object contents in the image/video, the choice of the direction (e.g., horizontal or vertical direction) for rectification may significantly affect the resolution of the rectified stereo depth and/or geometry consistency processing.

As one example, given a set of M available cameras (e.g., M=3), the SSS technique determines and switches for the optimal set of N (N≤M) at time t that best jointly handle stereo vision. As an example with reference to FIG. 2, with M=3 and N=2, processor 156 may be configured to implement operations including: based upon a new object detected, determine a subset of cameras from the plurality of cameras (e.g., subset of cameras=camera A and B or camera A and C) to provide stereo vision of the new object detected. Because of this processor 156 may automatically rotationally switch from the previously selected subset of cameras (e.g., camera A and B or camera A and C) for the previous object to the new subset of cameras for the new object. It should be appreciated that these cameras may be equivalent to camera 1 132 (camera A), camera 2 134 (camera B), and camera N 162 (e.g., camera C) from device 130 of FIG. 1.

Similarly, as one example, given a set of M available cameras (e.g., M=4), the SSS technique determines and switches for the optimal set of N (N≤M) at time t that best jointly handle stereo vision. As an example with reference to FIG. 2, with M=4 and N=2, processor 156 may be configured to implement operations including: based upon new object detected, determine a subset of cameras from the plurality of cameras (e.g., subset of cameras=AC, AB, CD, BD, AD, or CB) to provide stereo vision of the new object detected. Because of this processor 156 may automatically rotationally switch from the previously selected subset of cameras (e.g., AC, AB, CD, BD, AD, or CB) for the previous object to the new subset of cameras for the new object (e.g., another group of cameras−AC, AB, CD, BD, AD, or CB). This provides portrait and landscape orientations (AD, CB) as well as slanted orientations (e.g. AC, AB, CD, BD). It should be appreciated that these cameras may be equivalent to camera 1 132 (camera A), camera 2 134 (camera B), and cameras N 162 (e.g., cameras C and D) from device 130 of FIG. 1.

It may be assumed that the cameras are physically fixed and statically attached in, on, or to a device. As previously described, device 130 may be: a mobile device, a mobile phone, a vehicle, a robot, a stationary Internet of Things (IoT) device, a mobile IoT device, a security device, or any suitable device. Given the target object(s) in the image/video, an optimal subset of cameras are selected by minimizing the cost function in terms of the accuracy, consistency, quality, efficiency, or confidence, or any combination of these mentioned measures. One example of a suitable type of equation is set forth below:

$${λ}_{i} = {arg min}_{{λ}_{i} ϵΛ} C ( {F}_{L} , {F}_{R} , θ )$$

In this equation, Λ={λᵢ}, i=0,1, . . . , L−1 is the set of L pre-defined (valid) camera subset candidates, with each camera subset candidate λᵢ supporting rectified stereo depth and/or geometric estimation for stereo vision. As an example, λ₀=(A, C) and λ₁=(A, B) for M=3 in FIG. 2. F_{L} and F_{R} are the left and right encoded features based on the sources of left and right of camera subset λᵢ. θ is the set of additional arguments useful for evaluating the cost function.

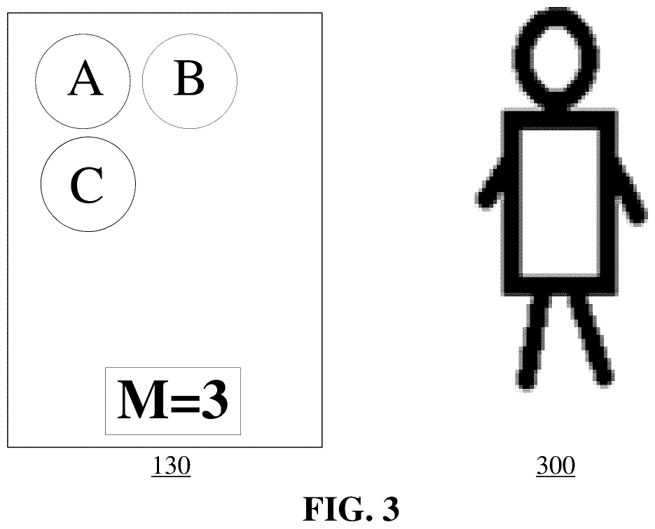

To support the determination and switching for the chosen orientation of a camera subset, switchable rectification may be supported according to the orientation of the chosen camera subset. For example, switchable rectification between (A, C) when λ₀ is chosen and between (A, B) when λ₁ is chosen. As a particular example, with additional reference to FIG. 3, utilizing the stereo sensor switching (SSS) technique, in which, device 130 under control of processor 156 automatically determines and switches for the best selection of stereo cameras out of available candidate cameras to support stereo vision of the object, in this scenario, camera subset 2=(A, C) from device 130 having M=3 cameras A, B, C, is selected, because the portrait orientation of cameras A,C of device 130 provides the best stereo accuracy of the object/person 302. Therefore, in some aspects, device 130 switches between orientations (e.g., portrait and landscape) based on the device's own calculations to automatically determine and switch cameras for the best selection of stereo cameras out of available candidate cameras to support stereo vision.

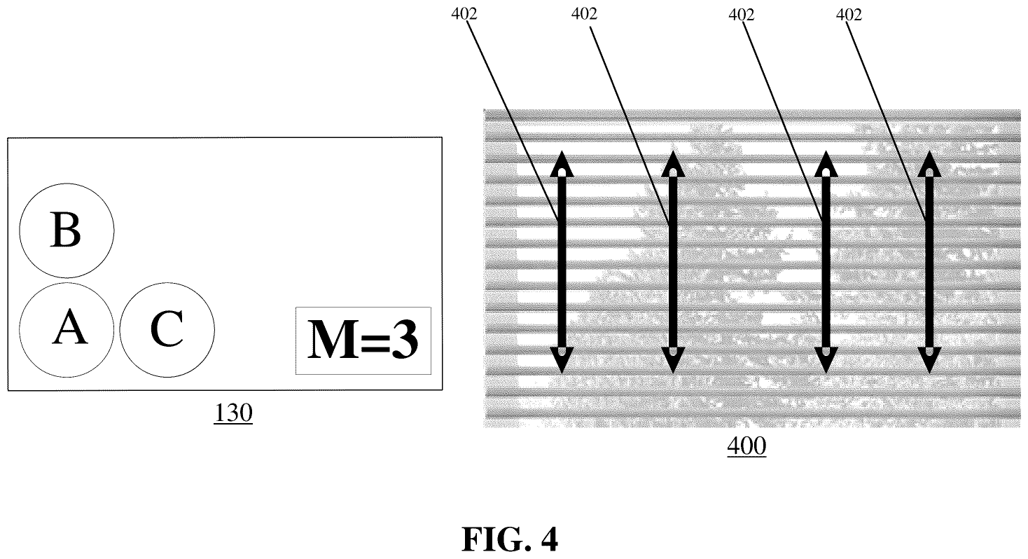

As another particular example, with additional reference to FIG. 4, utilizing the stereo sensor switching (SSS) technique, in which, device 130 under control of processor 156 automatically determines and switches for the best selection of stereo cameras out of an available candidate cameras to support stereo vision, image 400 shows strong directional textures where high-frequency details are rich along lines 402. In this example scenario, device 130 selects and switches to camera subset M=(A, B) because such directional high frequency (HF) details provide for the best stereo accuracy. In particular, in landscape mode, with cameras A,B, stereo vision of the object (e.g., trees) is optimal based upon the high frequency directional textures in determined directions (e.g., lines 402).

In one additional aspect, a use case of de-occlusion may be performed by performing the following asymmetric operations in the case of feature asymmetry in stereo images, to be described hereafter. First, feature asymmetry is identified with rectified left and right stereo images by taking (coarse-level) frequency-domain analysis of the stereo images. For example, an operation such as Fast Fourier Transformation (FFT) or Wavelet Transform with directional filtering may be performed to analyze if a certain degree of feature asymmetry is present with the stereo images. If feature asymmetry is present, then stereo rectification by switching to an appropriate pair of cameras for the dimension of rectification to align with the dimension of stronger (or richer) high-frequency response may be performed.

In order to take advantage of the stronger/richer insight in one particular dimension with observation of feature asymmetry, stereo depth estimation may be performed on top of the chosen dimension with stronger/richer high-frequency for rectification. Also, certain pixels or regions of an undesired object or classes may be chosen to be erased from the depth or disparity map. As an example, between the two heigh and weight spatial dimensions, after performing stereo depth estimation in the dimension of stronger/richer high-frequency components, the other (orthogonal) dimension is selected to perform asymmetric propagation or 1-dimensional (or directional) propagation in order to propagate, aggregate, and regress feature attributes of pixels towards (or biased in) the other (orthogonal) dimension. Examples of propagation method include the Patch Match algorithm, Markov Random Field algorithm, and Conditional Random Field algorithm, for which the asymmetric or directional propagation may be performed to favor stronger response in the selected dimension. Such asymmetric/directional propagation can propagate the strength/richness of insight in one direction to the other direction, such that the resultant feature map has reduced feature asymmetry or has (more) balanced feature symmetry. Further, after stereo depth estimation in the stronger/richer dimension and propagation/aggregation/regression in the other dimension, the occluded pixels and/or regions may be completed/filled with attributes from the reference pixels/regions that are not holes. Such asymmetric/directional propagation can be iterated multiple times such that the pixels/regions of holes are incrementally completely filled. It should be appreciated that this method above may be extended from 2D (H & W) space to 3D Euclidean space with 3D feature asymmetry in order to balance or re-balance feature symmetry in 3D. In this way, object de-occlusion out of the depth/disparity map can be achieved.

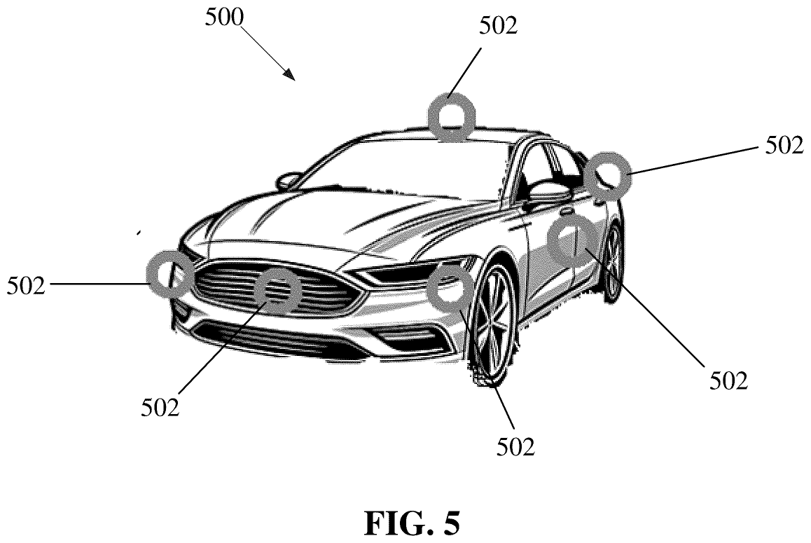

As another particular example, with additional reference to FIG. 5, a vehicle 500 may be utilized that has a plurality of cameras 502 around the vehicle 500. By utilizing a plurality of cameras 502 around the vehicle, the setting of candidate camera sets may be extended from the 2D plane, previously described, to a 3D Euclidian space. In this example, M cameras 502 may be assumed to be around the vehicle, providing a multitude of cameras around the vehicle 500. Therefore, utilizing this vehicle implementation, a processor 156 of vehicle 500 may be configured to: based upon a new object detected, determine a subset of cameras 502 from the plurality of cameras 502 to provide stereo vision of the new object and rotationally switch between a previously selected subset of cameras for a previous object to the new determined subset of cameras 502 for the new object to provide stereo vision of the object. It should be appreciated that the device 130 may be considered to be the vehicle 500 itself and/or be implemented by the vehicle. In this way, utilizing the stereo sensor switching (SSS) technique, the processor automatically determines and switches to the best selection of stereo cameras 502 out of all the available candidate cameras 502 about the vehicle, to support stereo vision of the new object. More details of a vehicle implementation will be discussed hereafter.

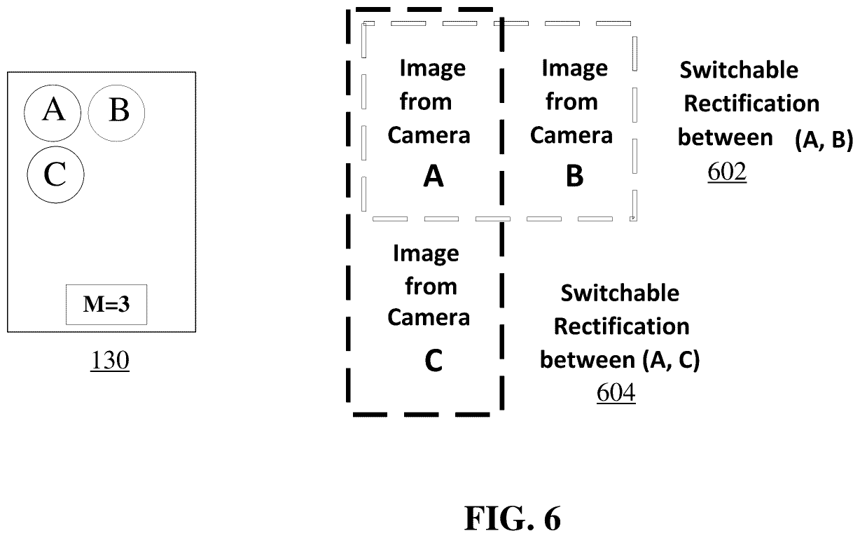

With additional reference to FIG. 6, the techniques of stereo sensor switching (SSS) and switchable rectification for combining multiple subsets of cameras will be described. FIG. 6 shows the previously described device 130 including three cameras A, B, and C and possible switchable selections A,B and A,C. In this implementation, the switching selection between cameras is also based upon multi-stereo rectification of cameras by combining multiple candidates of stereo camera subsets to further increase accuracy, consistency, diversity, and/or robustness. For example, in the previous example of M=3, device 130 may select both λ₀=(A, C) and λ₁=(A, B) such that additional pairs of stereo cameras can be employed for the same frame such that additional diversity for stereo reasoning and processing are done. This can be useful for high-accuracy and/or high-safety use cases, such as autonomous driving for a vehicle 500. It should be appreciated that these techniques for combing multiple subsets of camera from a plurality of different types of cameras may be utilized for various implementations, in which, the previously described device features for a device 130 combining multiple stereo camera candidates may be applied, such implementations including: a mobile device, a mobile phone, a vehicle, a robot, a stationary Internet of Things (IoT) device, a mobile IoT device, a security device, smart phones, XR glasses/headsets, vehicles, etc.

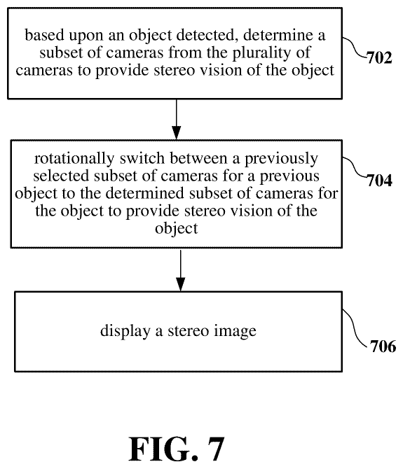

With brief reference to FIG. 7, a flowchart of the previously described method according to one aspect will be described. As previously described, aspects of the disclosure relate to rotationally switching between cameras to provide stereo vision of an object. At block 702, based upon an object detected (e.g., a new object), determine a subset of cameras from the plurality of cameras to provide stereo vision of the object (e.g., the new object). At block 704, rotationally switch between a previously selected subset of cameras for a previous object to the determined subset of cameras (e.g., the new subset of cameras) for the new object to provide stereo vision of the new object. At block 706, provide stereo vision of the new object.

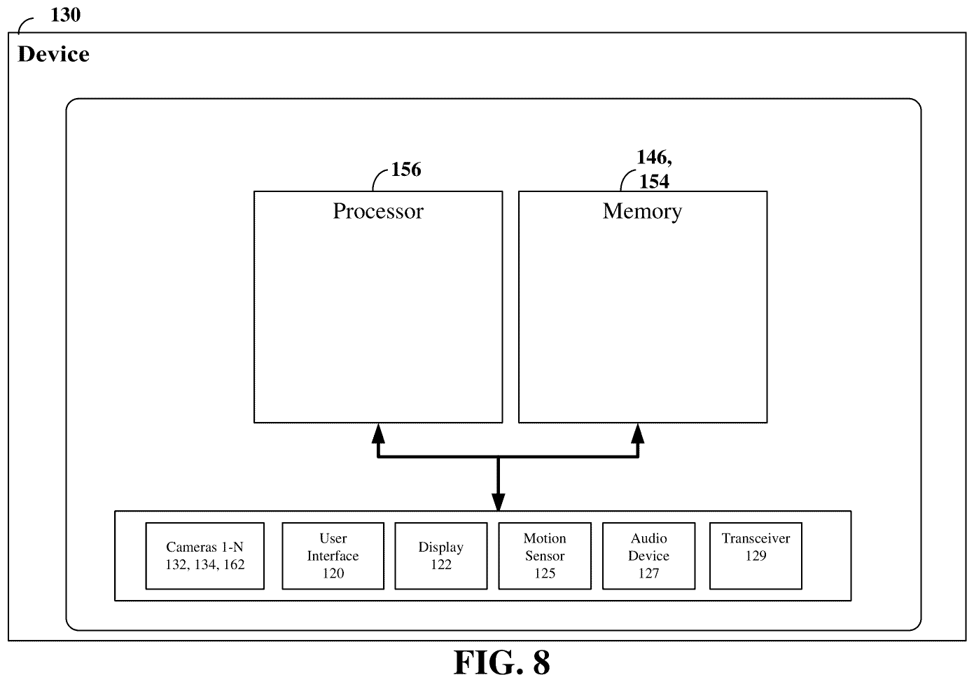

With brief reference to FIG. 8, FIG. 8 is a simplified diagram of FIG. 1. Like FIG. 1, FIG. 8 illustrates device 130 including: processor 156, memories 146, 154, and cameras 1−N(132, 134, 162), user interface 120, display 122, motion sensor 125, and transceiver or modem 129. FIG. 8 is a simplified diagram for case of reference to aid in illustrating particular implementations described below. As previously described, device 130 may be: a mobile device, a mobile phone, a vehicle, a robot, a stationary Internet of Things (IoT) device, a mobile IoT device, or a security device. However, these devices are just examples and it should be appreciated that device 130 may be any suitable device.

In one example, processor 156 of device 130 may utilize motion sensor 125 to detect if device 130 has switched from a first orientation to a second orientation (e.g., a portrait to orientation). However, it should be appreciated that any orientation may be possible dependent upon a measurement of degree of orientation (e.g., any degree of angle: 0-360 degrees). Based upon this, processor 156 of device 130 may be configured to: switch to a subset of cameras from the plurality of cameras (N-cameras 132, 134 162) to provide stereo vision of the object based upon the switch detected by the motion sensor 125 from the first orientation to the second orientation. As an example, the first orientation may be a portrait orientation and the second orientation may be a landscape orientation. In some example aspects, the device 130 may switch its own position/orientation from the first orientation to the second orientation (e.g., in a moveable/rotatable device). As previously described, with reference to FIG. 2, M=4, processor 156 may automatically rotationally switch from the previously selected subset of cameras (e.g., AC, AB, CD, BD, AD, or CB) for the previous object to the new subset of cameras for the new object (e.g., another group of cameras-AC, AB, CD, BD, AD, or CB). This provides portrait and landscape orientations (AD, CB) as well as slanted orientations (e.g. AC, AB, CD, BD). It should be appreciated that these cameras may be equivalent to camera 1 132 (camera A), camera 2 134 (camera B), and cameras N 162 (e.g., cameras C and D) from device 130 of FIG. 1.

For example, in one particular implementation of the features of rotationally switching between cameras in a device 130 to provide the best stereo vision of a new object, the implementation is where the device 130 is smart phone. For example, in a smart phone camera use case, a method is implemented that calculates and determines recommended poses (e.g., portrait or landscape) based on the captured stereo image inputs on the smart phone from the smart phone cameras (132,134, 162 . . . ) and indicates to the user visually (e.g., on display device 122) or by audio (e.g., through audio device/speaker 127) that in order for a better image/video processing quality and/or better stereo depth accuracy (i.e., a better display of the image) that the user select a particular pose (e.g., portrait or landscape). Therefore, the smart phone device 130 recommends to the user a best pose for the best video image quality based on camera processing of images.

As an example, in one aspect, device 130 is a mobile device (e.g., a smart-phone device) that includes: a user interface 120 to receive user input from the user; a display device 122 to display objects to the user; an audio device 127 to provide audio sound to the user; a transceiver 129 to transmit and receive data; and processor 156 is configured to record an image of the object based on the selected subset of cameras (e.g., camera 132, 134 . . . 162), in which the processor 156, for the user, is configured to: determine an orientation (e.g., portrait or landscape) of the mobile device 130 to provide the best stereo vision of the object and recommends to the user the best orientation (e.g., portrait or landscape) for the user to rotate the mobile device to in order to obtain the best image of the object. As previously described, the indication to the user of the orientation by the mobile device 130 may be visually (e.g., by a graphic indicator of the recommended orientation on display device 122) or by audio (e.g., through audio device/speaker 127). In this way, in order for a better image/video processing quality and/or better stereo depth accuracy (i.e., a better display of the image), the mobile device recommends that the user select a particular pose (e.g., portrait or landscape). Therefore, the mobile device 130 recommends to the user-a best pose for the best video image quality based on camera image processing. Also, it should be appreciated that device 130, besides visually or by audio recommending simply portrait or landscape positioning, device 130 may also recommend other sort of positioning recommendations, such as: a particular percentage orientation or angle of the device, facing the device up, facing the device down, turning the device right or left in a particular manner, etc.

For example, a user holding the smart phone device 130 in the portrait pose, shooting a video of a static car in an auto show, may receive on the display device 122 a recommendation from smart phone device 130 to rotate his or her phone by 90 degrees to shoot in a landscape pose instead—in order for higher video quality through the video processing (e.g., stereo depth assisted video processing). It should be appreciated that a mobile device 130, such as, a smart phone, has been described as an example but that any device 130 (e.g., laptop, personal digital assistant, watch, mobile computer, digital camera, etc.) moveable by user may be utilized, these just being non-limiting examples.

In one example aspect, a user can particularly select the object, and the object is recorded for the user based on the selected subset of cameras chosen by processor 156 of device 130, based on the previously described methods. For example, the user can completely select the object by themselves on device 130, and command that device 130 capture the object (and device 130 will automatically select the best subset of cameras, as previously described). The user can select the object by various implementations, such as, via user input from the user to command the capture of the image—e.g., via touch-screen on the display device 122, via pushing a user interface 120 button or keypad button; via an audio command through the audio device 127, etc. For example, a user, on the touch-screen display device 122 can select via finger circling a particular object e.g.—a car; a person; a tree; background-sky, grass; etc. As another example, the user could type on user interface 122 “photograph person” or speak to audio device 127 “photograph tree.” These are just examples of techniques that a user may utilize to command the device to capture an object and/or type of object. As previously described, device 130 may be a: laptop, personal digital assistant, watch, mobile computer, digital camera, mobile device, mobile phone, vehicle, robot, stationary Internet of Things (IoT) device, mobile IoT device, security device, or any suitable device.

It should also be appreciated that in another example aspect, an object may be detected and selected for image capture by device 130 based upon an object detection algorithm implemented by processor 156 of device 130 and device 130 will automatically select the best subset of cameras, as previously described, to image capture the objects commanded by the object detection algorithm. It should be appreciated that the object detection algorithm may be programmed to automatically command the image capture of such objects as: faces, cars, people, trees, animals, etc. The object detection algorithm may command the image capture of objects based upon the type of device 130: e.g., vehicle—other vehicles, animals, trees, people, etc.; security device-people, faces, guns, etc. As previously described, device 130 may be a: laptop, personal digital assistant, watch, mobile computer, digital camera, mobile device, mobile phone, vehicle, robot, stationary Internet of Things (IoT) device, mobile IoT device, security device, or any suitable device.

In one aspect, the determination for the recommended pose(s) of the user phone/camera may involve derivation of a cost function C in terms of the accuracy, consistency, and/or confidence measures for one of the candidate poses for the user device. Assuming the set Λ={λᵢ}, i=0,1, . . . , L−1 contains L pre-defined candidate poses of the device, we propose a device pose determination method as

$${λ}_{i} = {arg min}_{{λ}_{i} ϵΛ} C ( {F}_{L} , {F}_{R} , θ ) ,$$

where C is the cost function, F_{L} and F_{R} are the left and right encoded features based on the left and right, respectively, stereo images from the camera, and θ is the set of additional arguments useful for evaluating the cost function.

The method mentioned above may involve or calculate one of the following operations to help calculate/determine the recommended pose(s) of the user phone/camera: 1) feature similarity measurement, 2) geometric consistency measurement, 3) stereo left-right image/feature warping, 4) bounding box IoU measure, 5) rectification accuracy, or 6) estimation confidence measure.

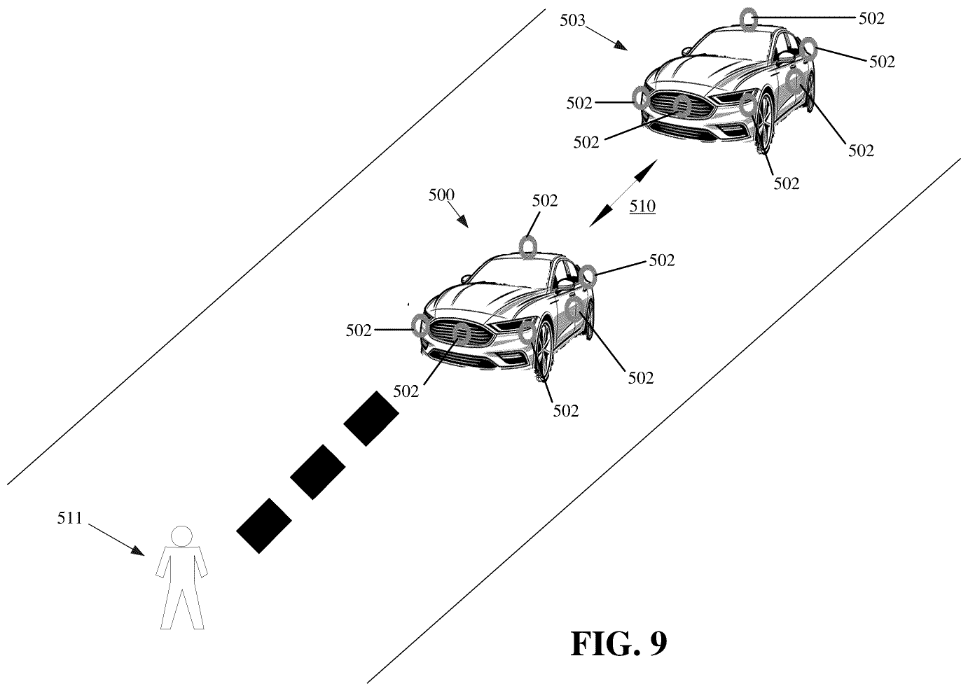

As will be described, an implementation utilizing the features previously described is very useful for a vehicle implementation. With reference to FIG. 9, as can be seen in FIG. 9, a relatively larger number of cameras 502 may be deployed on a vehicle 500 (e.g., 6 cameras on the car). Examples of first front vehicle 500 and a second back vehicle 503 on a road are shown. In particular, the first and second vehicles 500, 503 shown in FIG. 9 may be in communication with one another via a communication link 510. Each of the vehicles may include a plurality of cameras 502 to implement rotationally switching between cameras 502 on the vehicle to provide the best stereo vision of a new object.

As has been described, a vehicle 500 may be utilized that has a plurality of cameras 502 around the vehicle 500. By utilizing a plurality of cameras 502 around the vehicle, the setting of candidate camera sets may be extended from the 2D plane, previously described, to a 3D Euclidian space. In this example, M cameras 502 may be assumed to be around each vehicle, providing a multitude of cameras around each vehicle 500. Therefore, utilizing this vehicle implementation, a processor 156 of vehicle 500 (e.g., being implemented as device 130) may be configured to: based upon a new object detected (e.g., a person 510), determine a new subset of cameras 502 from the plurality of cameras 502 to provide stereo vision of the new object (e.g., the person 510) and rotationally switch between a previously selected subset of cameras for a previous object (e.g., a road-line 520) to the new determined subset of cameras 502 for the new object (e.g., person 510) to provide stereo vision of the new object (e.g., person 510). Back vehicle 503 operates in a same or similar manner.

In this way, by utilizing the stereo sensor switching (SSS) techniques previously described, the processor automatically determines and switches to the best selection of stereo cameras 502 out of all the available candidate cameras 502 about the vehicle 500, to support the best stereo vision of a new object (e.g., the person 510). It should be appreciated that the device 130 may be considered to be the vehicle itself and/or be implemented by the vehicle.

In this example, based upon a new object detected (e.g., a person 510), the processor determines a new subset of cameras 502 from the plurality of cameras 502 to provide stereo vision of the new object (e.g., the person 510) and rotationally switch between a previously selected subset of cameras for a previous object (e.g., a road-line 520) to the new determined subset of cameras 502 for the new object (e.g., person 510) to provide stereo vision of the new object (e.g., person 510). In this example, a pair of cameras 502 on the front end of the first vehicle 500 may be the previously selected subset of cameras monitoring the road-line 520. Next, a new subset of cameras 502, such as the top camera on-top of the first vehicle 500 and the center camera on the front-side of the first vehicle are switched to provide the best stereo vision of the new object-—the person 510.

Also, the vehicle 500 under the control of the processor may further be configured to combine multiple subsets of cameras from the plurality of cameras to provide better stereo vision of the object, as previously described. As an example, multiple camera sets may be combined to provide better stereo vision of the new object—e.g., person 510. For example, images of the person 510 from a pair of cameras on the front end of the vehicle may be combined with images of the person 510 from the top end of the vehicle and the side of the vehicle.

Additionally, it should be appreciated that as the first vehicle 500 is driving towards the object (e.g., a person 510), the processor of vehicle 500 monitors camera image input from the selected subset of cameras for the person/object 510 to monitor the distance between the vehicle 500 and the person/object 510 and for collision avoidance.

Furthermore, the processor of a vehicle is configured to combine object data received from a camera of another vehicle to provide stereo vision of the object. As an example, the front first vehicle 500 may, based on cameras 502, such as the top camera on-top of the first vehicle and the center camera on the front-side of the first vehicle obtain a stereo vision of the person 510. At the same time, second back vehicle 503, behind the front vehicle, may also begin to obtain data of person 510, based on its top camera and one of its front end cameras. The front first vehicle 500 may transmit the image data captured of person 510, and transmit it back through a communication link 510 to the back second vehicle 503, such that the back vehicle 503 can combine the stereo vision image data of person 510 from the front vehicle with its own stereo vision image data from its own cameras to obtain more accurate stereo image data of person 510. This can aid the second back vehicle 503 in monitoring the distance between the second back vehicle 503 and the person/object 510 and for collision avoidance.

As has been previously described, the processor of a vehicle is configured to combine object data received from a camera of another vehicle to provide improved stereo vision of the object. It should be appreciated that this methodology can be used in other implementations. For example, security cameras in a warehouse may similarly combine object data received from other security cameras to likewise improve stereo vision of objects. As another example, robots with cameras may similarly combine object data received from other robots with cameras to likewise improve stereo vision of objects. It should be appreciated that a wide variety of devices with cameras may combine object data received from other devices with cameras to likewise improve stereo vision of objects.

As has been described, by utilizing a larger number of cameras on a vehicle, stereo sensor switching techniques, switchable rectification techniques, and multi-view camera combination techniques may be utilized together. The combination of these techniques, as has been described, may minimize the cost function among all possible hypotheses of stereo cameras available on the vehicle and stereo depth for the stereo images obtained by the vehicles may also benefit.

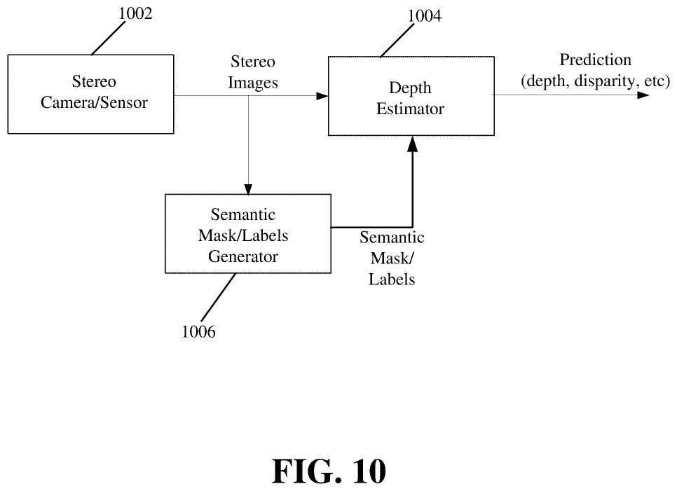

In one additional example aspect, with additional reference to FIG. 10, device 130 may also utilize a semantic generator 1006 that may be used to produce information (e.g., semantic masks/labels), which can be fed into a stereo depth estimator 1004 to assist in detection, localization, selection, and/or conditioning along with the stereo (L & R) image inputs from stereo cameras 1002 to assist with stereo depth estimation by stereo depth estimator 1004. It should be appreciated that stereos cameras 1002 are similar to the previously described N-cameras (e.g., camera 1 132, camera 2, camera N 162), but that other sensors, as previously described, could be utilized. As an example, semantic label generator 1006 outputs a semantic label based upon an image captured by left/right cameras 1002 to stereo depth estimator 1004, and depth estimator 1004 utilizes the labels to assist in stereo depth estimation to produce stereo vision of images. It should be appreciated that device 130 may implement semantic label generator 1006 and depth estimator 1004 under the control of processor 154. The semantic masks/labels may be one or more of semantic masks/labels, instance masks/labels, foreground/background masks/labels, etc.

As an example, in image processing, a semantic mask or label may be a class label assigned to each pixel in an image. Semantic labels may be used to show the relationship between pixels and different object classes, which helps to understand the content of an image. Semantic labels may be used in semantic segmentation, which is a data labeling task in machine learning and computer vision. Semantic segmentation may be used to teach a device to recognize different objects and scenes in images and videos.

According to some aspects, device 130 under control of processor 154 may utilize these semantic operations to teach device 130 to recognize different objects and scenes in images and videos. As one example of implementation, a reference image is captured by stereo cameras 1002 (e.g., a left image) and is fed to a semantic generator 1006. Semantic generator 1006 produces semantic labels for pre-defined semantic classes (e.g., the class of a human, a car, the road, the sidewalk, the tree, etc.). In particular, when a particular semantic class (e.g., the human class) is indicated along with the reference image input to the semantic generator 1006, the output to depth estimator 1004 may include a (dense) binary mask that indicates whether a pixel in the reference image input is predicted as the particular semantic class (e.g., “1” for human) or not the particular semantic class (e.g., “0” for non-human). Therefore, as an example, this output semantic mask may contain only 1s and 0s to indicate whether a pixel (x,y) is of the particular semantic class when the mask value is “1” or “0” otherwise at pixel (x,y).

This semantic mask may then be further fed into the stereo depth estimator 1004 to assist with depth or disparity prediction for the stereo input images. The stereo depth estimator 1004 can leverage such mask to help associate pixels in a neighborhood based on the mask values to better predict the depth (or disparity) for pixels of the same mask values. For example, for pixels in a neighborhood indicated by the semantic mask to be “1” (e.g., human), the stereo depth estimator 1004 may utilize such mask values of 1 for those pixels to improve the consistency of predicted depth (or disparity) values to be of same value range, as the particular region of pixels are likely to be of the same object (e.g., a human) of similar depth (or disparity). This helps not only the consistency in depth (or disparity) prediction, but it also helps improve the object boundaries as a boundary between pixels of mask values of 1 and of 0 are likely the object boundary between the particular object (e.g., human) and else (e.g., non-human) and therefore the depth (disparity) values at the boundary are likely to be of difference range (e.g., due to different depths to the human and to the background at the human boundary).

Therefore, the previously described implementation may assist in stereo depth estimation in stereo vision processing to produce stereo vision of objects and images. This sort of implementation may be beneficial in the previously described examples, of vehicles, mobile devices, robots, security devices, etc., to provide improved stereo vision of objects and images.

As previously described, it should be appreciated that by having multiple cameras (e.g., cameras 132, 134 . . . 162) on device's 130 and by providing multiple choices of stereo cameras, device 130 may select the most accurate stereo vision (also based on geometric disparity/depth). In particular, as previously described, device 130 use of stereo camera switching and switchable rectifications enables higher accuracy, consistency, diversity, and/or efficiency, due to its novel technique for the minimization of the cost function among all possible hypotheses of stereo cameras available on the device. Also, as previously described, when directional textures are present with high frequencies rich only in certain directions in the image/video contents, aspects of the disclosure provide a benefit over prior implementations, in that cost minimization among possible stereo candidate hypotheses is enabled. This is useful as stereo depth is known to be suffer from texture-less contents if neither directions of textures can be captured by the stereo processing. Also, for use cases, such as, those requiring high accuracy or high safety may benefit from the previously described multi-stereo rectification to include additional directions of stereo processing for increased diversity, leading to higher accuracy and consistency.

It should be appreciated that the features previously described for rotationally switching between cameras in a device to provide stereo vision of an object may be utilized for a wide variety of different devices 130. In particular, these type of digital video capabilities may be incorporated into a wide range of devices, including mobile devices, mobile phones, vehicles, robots, a stationary Internet of Things (IOT) device, a mobile IoT device, security device, digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Also, as has been described, such devices may be implemented in scenarios related to vehicles, mobile devices, security, etc.

As has been described, various implementations may assist in stereo depth estimation in stereo vision processing to produce stereo vision of objects and images. In one aspect, asymmetric down-sampling operations for height and width may be utilized to improve stereo vision. As an example, asymmetric down-sampling operations for height and width of images and objects to provide improved or modified stereo vision, in which, the asymmetric down-sampling operations may include a higher resolution in width, may be utilized. The techniques may be utilized with the previously described techniques to provide higher stereo depth accuracy only as necessary in terms of only the needed dimension and needed regions or patches to avoid waste in computation in unnecessary dimensions or unnecessary regions or patches.

Improved or modified stereo vision processing that utilizes an asymmetric down-sampling operation for the height and width of the object, in which, a higher resolution is in width, will now be described in greater detail. Aspects of the disclosure relate to a description of an improved stereo vision processing implementation that utilizes an asymmetric down-sampling operation for the height and width of the object, in which, a higher resolution is in width. Aspects of the disclosure relate to a device or system that provides multi-aspect-ratio implementation in encoding or down-sampling for stereo disparity estimation. For example, multi-aspect-ratio encoding for stereo depth is presented that provides for disparity preservation and width-centric processing for disparity handling. Further, as will be described, asymmetric space-to-depth encoding and depth-to-space decoding is provided for disparity estimation. For example, disparate-rate height-width space-to-depth encoding and disparate-rate height-width depth-to-space encoding will be described.

Aspects of the disclosure generally relate to down-sampling, and more particularly, to down-sampling in different directions. As will be described, aspects of the disclosure relate to down-sampling for stereo depth estimation utilizing asymmetric operations in different directions (e.g., in width and height). As shown in FIG. 1, device 130 may include one or more memories 146, 154 that are configured to store a plurality of images from cameras 132, 134. Cameras 132,134 may be configured to capture a left and right image, respectively, in which, each of the images includes one or more patches, each patch including plurality of pixels. Device 130 may further include one or more processors 156 that are coupled to the memories. Processor 156 may be configured to: down-sample in a first direction on a first set of pixels in a first patch of a first image to generate a first down-sample; and down-sample in a second direction on a second set of pixels in a second patch of a second image to generate a second down-sample, in which, the second down-sample includes a greater number of pixels. As has been described, processor 156 may implement the functions of an encoder and/or decoder or separate encoders and/or decoders may be utilized on the same device or different devices.

In one example, as be described in more detail hereafter, the first down-sample in the first direction is in height and the second down-sample in the second direction is in width, such that, the first and second down-sample is an asymmetric down-sample operation that includes a higher resolution in width.

Therefore, in one example, the left camera 132 is configured to capture the left image and the right camera 134 is configured to capture the right image, and the one or the processors 156 are configured to generate both the first and second down-samples in both height and width from each of the left and right images, respectively. In this way, device 130 may be configured to implement asymmetric operations for the width and height of the image captured by the plurality of cameras 132, 134 during down-sampling operations, in which, the asymmetric operations include higher resolution in width. Based upon the asymmetric operations, stereo vision of the image may be provided. Utilizing these techniques, stereo vision is provided that preserves disparity and enhanced resolution, while still being performed in an efficient manner. For example, stereo vision of the image may be displayed on a display device 122. In particular, by utilizing these techniques, stereo vision is provided that preserves disparity and enhanced resolution, by focusing more on width than height, while being done in a more efficient computational manner, which results in less computational tasks and less power than the conventional processes. It should be appreciated that terminology down-sampling and encoding and up-sampling and decoding are used interchangeably throughout the disclosure.

Aspects of the disclosure relate to a device or system that provides multi-aspect-ratio implementation in down-sampling for stereo disparity estimation. For example, multi-aspect-ratio down-sampling for stereo depth is presented that provides for disparity preservation and width-centric processing for disparity handling. Further, as will be described, asymmetric space-to-depth encoding and depth-to-space decoding is provided for disparity estimation. For example, disparate-rate height-width space-to-depth encoding and disparate-rate height-width depth-to-space encoding will be described.

The improved or modified stereo vision processing implementation that utilizes an asymmetric down-sampling operation for the height and width of the object, in which, a higher resolution is in width, will now be described in greater detail. Aspects of the disclosure relate to a description of improved or modified stereo vision processing implementation that utilizes an asymmetric down-sampling operation for the height and width of the object, in which, a higher resolution is in width.

It should be appreciated that system or device 130 is merely an example. Further, as has been described, processor 156 may implement the functions of an encoder and/or decoder or separate encoders and/or decoders may be utilized on the same device or different devices.

In one aspect, to address problems associated with the previously described common practice of an encoder performing feature extraction by down-sampling feature maps that results in the loss of critical details and depth estimation accuracy, aspects of the disclosure provide embodiments related to multi-aspect-ratio down-sampling for stereo depth that provide for disparity preservation and width-centric processing for disparity preservation. The multi-aspect-ratio down-sampling for stereo depth and width-centric processing methods to be described estimate pixel-wise disparities between rectified stereo images in a manner that provides for disparity preservation. In one aspect, the disparity information per-pixel is carried by stereo inputs. As one example, processor 156 may operate as a feature extractor and/or encoder for down-sampling and may implement a machine-learning (ML) module to implicitly carry the disparity information.

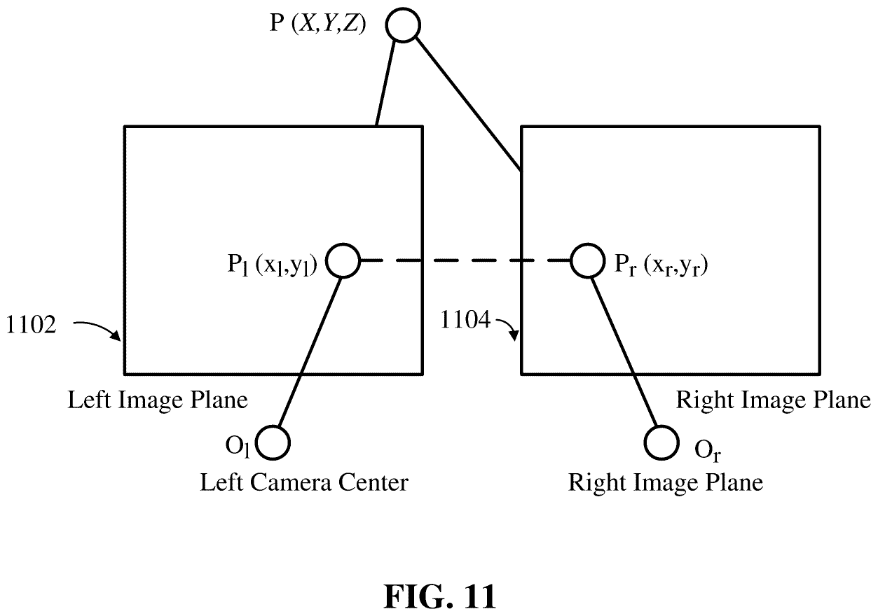

As an example of implementation, with reference to FIG. 11, a world point P (X, Y,Z), a left image plane 1102 of the left camera, and a right image plane 1104 of the right camera are shown. Further, the left camera center O₁ and right center camera Oᵣ are shown. Based upon these points, p₁ (x₁,y₁) and pᵣ (xᵣ,yᵣ) on the left image plane and the right image plane are shown, respectively. It should be noted that in this horizontally rectified stereo set-up, the disparity information is carried between the stereo images for the world point P, which is projected on the stereo left and right images 1102 and 1104. In particular, the width disparity may be considered to be xᵣ-x₁.

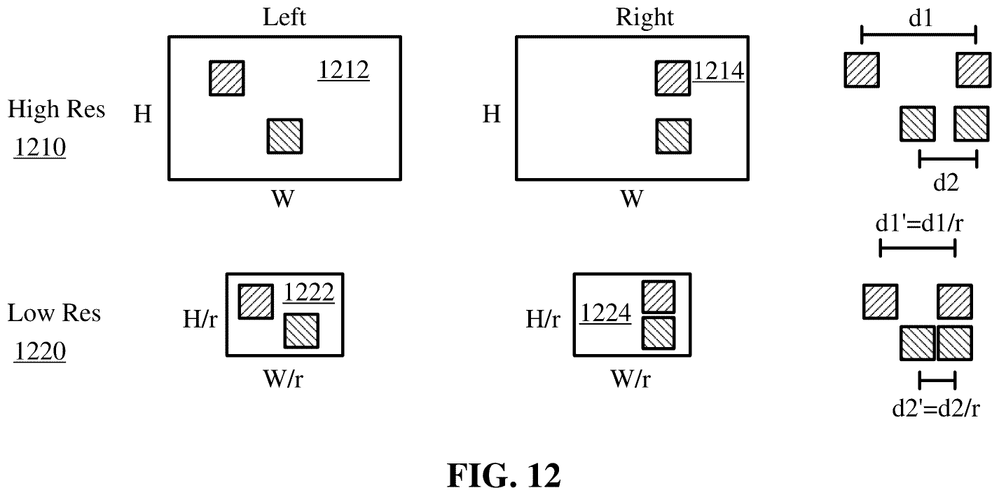

With additional reference to FIG. 12, FIG. 12 illustrates disparities between pixels on the left and right image planes. As can be seen in FIG. 12, with respect to a top high resolution example 1210, a left and right image plane 1212 and 1214 are shown, each having top and bottom pixels (the left and right image planes, having a y-axis in height (H) and x-axis in width (W)). In particular, as shown, the disparities between the top and bottom pixels on the left image plane 1212 and the right image plane 1214 are shown as d1 and d2. The disparities may be considered equivalent to xᵣ-x₁, as previously described (e.g., in the width dimension).

Now considering the effect of the image down-sizing by a factor of r (e.g., r=2, 4, 8, etc.) a lower resolution example 1220 is shown, again with a left and right image plane 1222 and 1224, each having top and bottom pixels (the left and right image planes, having a y-axis in height (H/r) and x-axis in width (W/r)). As can be seen in this example, the down-sized (e.g., lower resolution) images are now shown with reduced disparities of d1′=d1/r and d2′=d2/r, which are down-scaled by a factor of r. Accordingly, the model accuracy of disparity estimation is directly affected in width (e.g., horizontally), whereas height has not been found to be as an important of a factor. The utility of this disparity hypothesis will be further described hereafter in detail.

According to aspects of the disclosure, a technique for stereo depth estimation, in which, the disparity information as carried in the pixel-wise distance between the left and right image pairs (e.g., as previously shown in FIG. 12) and the encoded latent left and right (L and R) features is preserved. Further, convolution networks (e.g., neural networks) can further utilize these down-sized input images and latency encoded feature maps. It has been found in prior art implementations, that downsizing equally in height and width results in poor disparity estimation, whereas, aspects of the disclosure provide an approach to utilizing disparate down-sampling between height and width by keeping higher resolution in width (than in height) to better preserve disparity insight for stereo depth estimation.

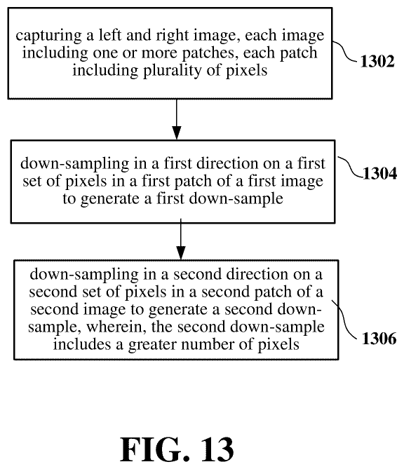

With reference to FIG. 13, FIG. 13 is a flowchart illustrating down-sampling, in accordance with one or more techniques of this disclosure. At block 1302, one or more images are captured, in which each of the images includes one or more patches, each patch including a plurality of pixels. At block 1304, down-sampling occurs in a first direction on a first set of pixels in a first patch of a first image to generate a first down-sample. At block 1306, down-sampling occurs in a second direction on a second set of pixels in a second patch of a second image to generate a second down-sample, wherein, the second down-sample includes a greater number of pixels.

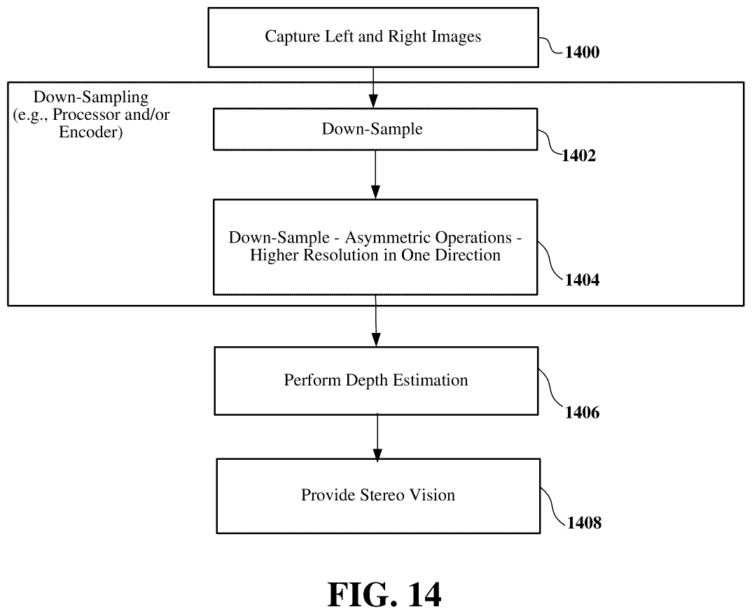

With reference to FIG. 14, FIG. 14 is a diagram illustrating an example operation for down-sampling images, in accordance with one or more techniques of this disclosure. The operations presented in the flowcharts of this disclosure are provided merely as examples. At block 1400, left and right images are captured from left and right cameras (e.g., cameras 132 and 134). At block 1402, down-sampling occurs. As an example of down-sampling, down-sampling may occur asymmetrically with higher resolution in one direction (block 1404). As has been previously described, in one aspect, down-sampling occurs in a horizontal directional on a first set of pixels on each of the left and right images to generate a horizontal down-sample, and, down-sampling occurs in a width direction on a second set of pixels on each of the left and right images to generate a width down-sample, in which, the width down-sample includes a greater number of pixels. In this way, the down-sampling is any asymmetric down-sample operation that includes a higher resolution in width. Stereo depth estimation may then be performed based upon the down-sampling operation (block 1406), as will be described in more detail hereafter. Further, as an example, processor 156 may render the output of the down-sampling for the left and right images and combine the left and right rendered images to generate a stereo image that is displayed on a display device 122 (block 1408), as will be described in more detail hereafter.

Therefore, down-sampling operations may be performed that are asymmetric (e.g., they may include higher resolution in width). In one example aspect, multiple asymmetric down-sample operations may be performed, in which, each asymmetric down-sample operation includes a pre-determined width-to-heigh aspect ratio.

In one example aspect, assuming the aspect ratio to a processing operation i is denoted as

$${γ}_{i} = \frac{{w}_{i}}{{h}_{i}} ,$$

i=1, 2, . . . , Iv among a total of N operations of the model starting with i=1 for the first model operation in training or inference by a processor (e.g., processor 156 implementing a ML neural network), where hᵢ and wᵢ are the height and width for operation i, then the model architecture may include the property of multiple-aspect ratios for encoding and decoding features:

$${γ}_{i} \leq {γ}_{j} for i < j during encoding ( down - sampling stages ) among \{ 1 , 2 , … , N \} , and$$

$${γ}_{i} \leq {γ}_{j} for i < j during decoding ( up - sampling stages ) among \{ 1 , 2 , … , N \} .$$

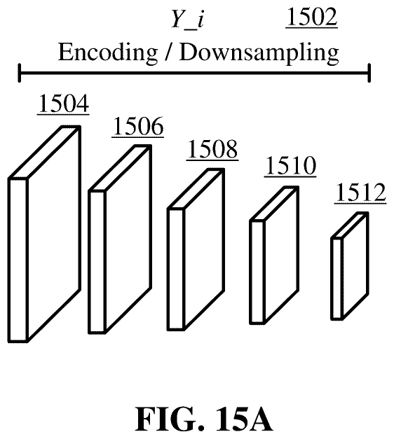

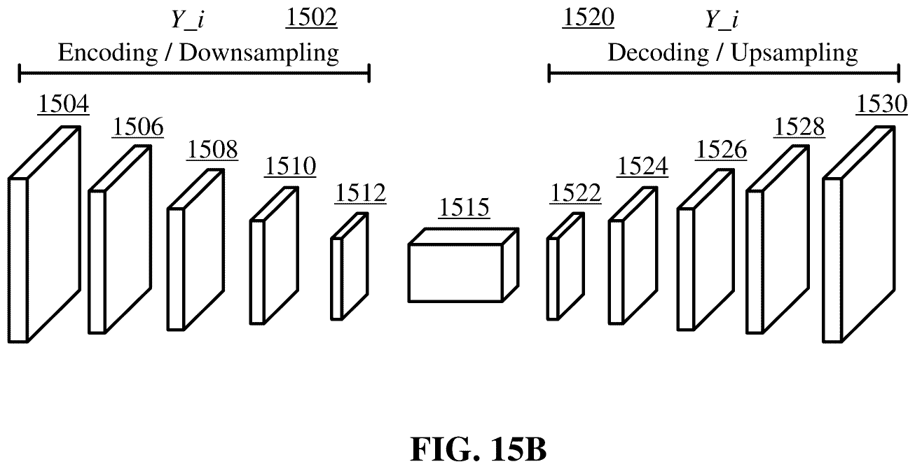

With reference to FIG. 15A, FIG. 15A is a diagram illustrating encoding/down-sampling utilizing multiple-aspect ratios. As will be described in FIG. 15B, mirrored decoding/up-sampling will also be shown. As shown in FIG. 15A, encoding/down-sampling 1502 illustrates encoding/down-sampling of image data that is down-sized by a factor of yᵢ (e.g., i=1, 2, 3, 4, 5), such that the first encoded data image block has a down-size factor of i=1 [y₁] 1504 (stage 1), the second encoded image data block has down-size factor i=2 [y₂] 1506 (stage 2), the third encoded image data block has down-size factor i=3 [y₃] 1508 (stage 3), the fourth encoded image data block has down-size factor i=4 [y₄] 1510 (stage 4), and the fifth encoded image data block has down-size factor i=5 [y₅] 1512 (stage 5). Each of these image data blocks 1504, 1506, 1508, 1510, and 1512 (stages 1, 2, 3, 4, 5) is down-sized with an asymmetric aspect ratio

$${γ}_{i} = \frac{{w}_{i}}{{h}_{i}} ,$$

such that, horizontal width is weighted with more importance than height.

In this example of the encoding/down-sampling 1502, assuming the aspect ratio to this processing operation is set in a processing encoder (e.g., implementing a ML neural network (e.g., implemented by processor 156 or a particular encoder)), in which the aspect ratio, is defined as denoted as.

$${γ}_{i} = \frac{{w}_{i}}{{h}_{i}} ,$$

i=1,2, . . . , N among a total of N operations (e.g. N=5) of the model starting with i=1 for the first model operation in training or inference and proceeding to i=5, where h; and w; are the height and width for each operation i, then the model architecture may include the property of multiple aspect ratios to encoded features-which can be seen as down-sized image data blocks 1504, 1506, 1508, 1510, and 1512 (stages 1, 2, 3, 4, 5).

It should be appreciated that in prior art implementations, down-sample factors in terms of width and height are be equally-weighted in terms of height and width. An example of this would be equally down-sizing in both height and width by: ½, ¼, ⅛, etc. For example, in prior down-sampling implementations R_h=R_w in each stage of down-sampling. For example, going from stages: 1 à 2 à 3 à 4 à 5-the pair R_h=R_w may be (2,2) à (2,2) à (2,2) à (2,2) à (2,2). However, in the aspects of previously described disclosure,

$${γ}_{i} = \frac{{w}_{i}}{{h}_{i}} ,$$

i=1,2, . . . , N−R_h≥w is implemented in each stage of down-sampling. For example, going from stages: 1 à 2 à 3 à 4 à 5 (1504, 1506, 1508, 1510, 1412)—the pair (R_h, R_w) may be: (4,2) à (2,1) à (2,2) à (2,1) à (2,2). Other down-sizing implementations are also possible. However, because R_h≥R_w is held true for each of the stages, implementing 5 stages in this example (1504, 1506, 1508, 1510, and 1512), resolution is preserved in the dimension of width better than in height. It should be appreciated that multiple width-to-height aspect ratios may be used during down-sampling/encoding. Also, the multiple width-to-height aspect ratios may be equal or increasing or decreasing during down-sampling/encoding operations.

With additional reference to FIG. 15B, in some example aspects, these down-sampled image data blocks 1504, 1506, 1508, 1510, and 1512 can be up-sampled by an automatic decoder 1515, in which, the up-sampled image data blocks are in the same feature/space domain and exactly match the down-sized image data blocks, as shown on the decoding/up-sampling side 1520—as image data blocks 1522, 1524, 1526, 1528, and 1530. However, the use of decoder 1515 is completely optional. In general, decoded or up-sampled image data blocks 1522, 1524, 1526, 1528, and 1530 that may be utilized would exactly match the corresponding down-sampled image data blocks.

By utilizing the previously described multi-aspect-ratio down-sampling implementations that focus more on width than in height for stereo depth (e.g., width-centric), pixel-wise disparities between rectified stereo images are processed in a manner that provides disparity preservation. In one aspect, the disparity information per-pixel is carried by the stereo inputs and is then down-sampled/encoded as previously illustrated. In one aspect, processor 156 may utilize an ML model to perform the previously described functions of down-sampling. Further, as example aspects, by utilizing encoder(s) that operate as ML modules the disparity information may be implicitly carried. The modules utilizing ML (e.g., encoder) can utilize learning and/or inference.

Therefore, as has been described, processor 156 may operate to perform down-sampling/encoding functions and can implement the ML functions for learning and/or inference. Also, it should be appreciated that variants in the model architecture may include multiple encoders, multiple decoders, interleaved encoder-decoder module (e.g., hour-glass modules, etc.). Further, it should be appreciated that a wide variety of neural network models, neural processors, neural hardware and/or software accelerators, etc. may be utilized. In a broad aspect, processor 156 may implement ML models during down-sampling and/or up-sampling to perform down-sampling/encoding functions and/or up-sampling/decoding functions and can implement ML functions for learning and/or inference.

In one example aspect, an up-sampling process implemented by processor 156 (or a separate decoder) may be used for stereo depth. In this case, a “coarse-to-fine” feature may be used for stereo depth as an overall algorithm to start stereo estimation at the coarse level before continuing to the next finer level. One reason for such type of stereo depth algorithm is that local minimums can be effectively removed/reduced. In this example, both down-sampling in the encoding feature and up-sampling in the coarse-to-fine stereo depth may be used in order for the overall stereo depth algorithm to properly run. Also, an up-sampling process may be used to serve two purposes: 1) to support multi-resolution stereo matching algorithm with a mixture of respective fields; and 2) to recover the estimated stereo disparity/depth map back to the original or desirable (higher) resolution. Therefore, the stereo matching algorithm may be used to leverage the coarse-to-fine resolution levels to avoid local minimums in optimization.

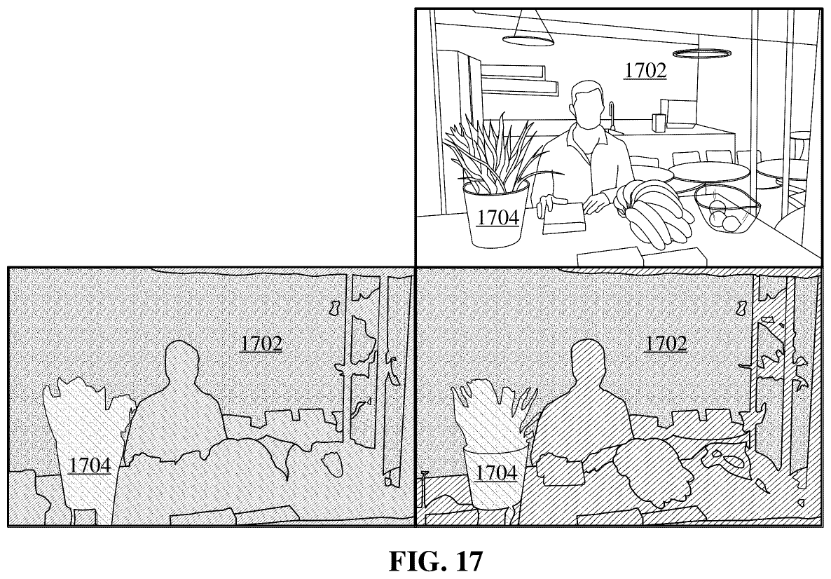

Further, additional layers of 2D convolution functions and/or 3D convolution functions may be implemented that provide spatial filtering on top of the previously described asymmetric down-sampling operations. This allows processor 156 implementing ML functions for learning and/or inference (e.g., implementing a neural network) to obtain more opportunities for learning and inference. Based upon the ML-based stereo matching algorithm and filtering functions during the down-sampling by the processor 156, the stereo image output rendered by the down-sampling process is improved and includes stereo depth map resolution that closely replicates the original stereo depth map resolution associated with the original stereo image. An example of the stereo depth map resolution will be described with reference to FIG. 17. As previously described, processor 156 of device 130 may command the display on a display device 122 of the stereo image output (as will be described with reference to FIG. 17).

In one example aspect, based upon the implementation of the ML model during the down-sampling process 1502 by the processor 156, the stereo image output rendered by the down-sampling process is improved and includes stereo depth map resolution that closely replicates the original stereo depth map resolution associated with the original stereo image. An example of the stereo depth map resolution will be described with reference to FIG. 17. As previously described, processor 156 of device 130 may command the display on a display device 122 of the stereo image output (as will be described with reference to FIG. 17).

It should be appreciated that artificial intelligence (AI) functionality and machine learning (ML) functionality may be utilized in these operations for learning, inference, etc., in the encoding, decoding, and other operations. AI generally is a field of research in computer science that develops and studies methods and software that enable machines to perceive their environment and use learning and intelligence to take actions that maximize their chances of achieving defined goals, such as, making predictions, recommendations or decisions influencing real or virtual environments. In particular, AI is a set of technologies that enable computers to perform a variety of advanced functions, including the ability to see, understand and translate spoken and written language, analyze data, make recommendations, and many other functions. ML may be considered a field of study in AI concerned with the development and study of statistical algorithms that can learn from data and generalize to unseen data and thus perform tasks without explicit instructions. The term AI/ML prediction, learning, inference, etc., referred to herein, may be any type of AI and/or ML related techniques, processes, algorithms, etc., that may be utilized herein to achieve the described functions. In other aspects other techniques that are not AI and/or ML related may be utilized to achieve the described functions.

According to aspects of the disclosure, the previously described techniques for stereo depth estimation, that utilize multi-aspect-ratio down-sampling 1502 implementations that focuses more on width than in height for stereo depth (e.g., width-centric) results in pixel-wise disparities between rectified stereo images being processed in a manner that provides disparity preservation. In this way, the previously described down-sampling process 1502 that implements down-sampling operations provides stereo vision of images with improved disparity preservation. Also, by utilizing the previously described techniques of the disclosure, stereo vision is provided that preserves disparity and enhanced resolution, while being done in a more efficient computational manner by focusing more on width than height, which results in less computational tasks and less power than the conventional process.

In another aspect, width-centric or disparity-dimension-centric processing may be utilized in down-sampling and up-sampling operations to provide stereo vision of an image in order to provide improved disparity preservation. Width-centric or disparity-dimension-centric processing may be utilized in down-sampling and up-sampling operations to facilitate improved learning and/or inference in ML model implementations to provide improved disparity preservation. In one aspect, asymmetric operations during down-sampling and up-sampling operations to increase width dimension weighting may be utilized. In one example aspect, an asymmetric attention mechanism may be performed to focus more heavily on the width dimension. As an example type of asymmetric attention mechanism, variable width-to-height ratios for derivation of queries, keys, and/or values in favor of features in the width dimension may be utilized.

As one particular type of asymmetric operations, asymmetric tokenization rates in the width dimension may be utilized. As an example of an asymmetric operation, asymmetric operations that include the use of asymmetric patchification based upon asymmetric tokenization rates to increase width-to-height ratios of input images to allocate more patches in width than in height during asymmetric patchification may be utilized. As an example of asymmetric patchification, width-to-height ratios for 2D patches of features may be increased for encoding. For example, when provided an original R=W/H for an input, more patches may be allocated in width than in the height during patchification, such that, after patchification, the 2-D patches have an increased ratio of R′=W′/H′>R=W/H. Therefore, patchification may be utilized as a special case of tokenization for 2D inputs in computer vision.

As another type of asymmetric operation, 1-D convolution for disparity-centric processing by focusing on the width dimension may be utilized in encoding and decoding operations to provide stereo vision of an image in order to provide improved disparity preservation. As to one type of asymmetric operation, asymmetric operations may include the use of variable-rate dilation for convolution in favor of the width dimension. As an example, when provided with 2-D inputs, dilated convolution that allows for asymmetric dilation rates between width and height dimensions may be utilized in favor of the width dimension. As another type of asymmetric operation, asymmetric operations may include the use of 1-D convolution for disparity-centric processing by focusing on the disparity dimension. For example, asymmetric separable convolution may be performed over the H and W dimensions. As one example, separable 1D convolutions may be performed over the H and W dimension, but with different kernel sizes in favor of the width dimension. As one particular example, Conv1D of kernel Kh in height may be performed and another Conv1D of kernel Kw in width may be performed, where Kw>Kh so that the width dimension is favored. As another type of asymmetric operation, asymmetric kernels (or asummetric strids) for convolution to favor the width dimension may be utilized in encoding and decoding operations to provide stereo vision of an image in order to provide improved disparity preservation. For example, when provided with 2D inputs, a square K×K kernel for 2-D convolution may be utilized, such as 3×3. By utilizing asymmetric kernel convolution, Kh×Kw, may be utilized, where Kw>Kh, to favor the width dimension for more kernel weights to handle more details in the width dimension.

As yet another type of asymmetric operation according to another aspect, asymmetric Space-to-Depth (S2D) and Depth-to-Space (D2S) operations may be utilized. In current S2D/D2S operations, symmetric rates for Height (H) and Width (W) are utilized. According to another aspect, asymmetric S2D operations and asymmetric D2S operations for stereo depth estimation may be utilized in encoding-decoding implementations that focus more on width than in height for stereo depth results in pixel-wise disparities between/among rectified stereo images being processed in a manner that provides disparity preservation.

As one example, asymmetric operations include the use of asymmetric S2D operations in the width dimension, in which, a smaller rate through division in the disparity width dimension is used than in other non-disparity dimensions. In particular, in order to preserve more feature information in the width dimension, a smaller rate through division in the width dimension than in the other non-disparity dimension is utilized when performing S2D operations.

As another example, asymmetric operations include the use of asymmetric D2S operations in the width dimension, in which, a larger rate through multiplication in the width dimension is used than in other non-disparity dimensions. In particular, in order to gain more feature information in the width dimension, a larger rate through multiplication in the width dimension is used than in the other non-disparity dimension.

In prior implementations, S2D operations and D2S operations were performed with symmetric rates, for down-sampling and up-sampling, in terms of [N, C, W, R].

In this implementation, N corresponds to batch, C corresponds to channel, H to height, W to width, and R to rate.

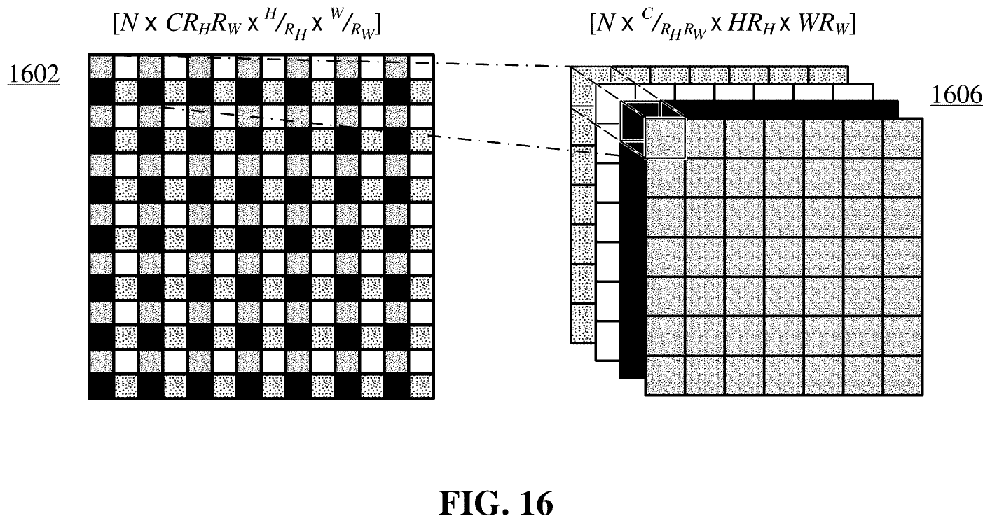

As can be seen with reference to FIG. 16, according to aspects of the disclosure, asymmetric operations include the use of asymmetric S2D operations in the width dimension for down-sampling 1602 (on the left side of the FIG. 16), in which, a smaller rate through division in the disparity width dimension is used than in other non-disparity dimensions. In particular, in order to preserve more feature information in the disparity dimension, a smaller rate “R” through division in the width dimension than in the other non-disparity dimension is utilized when performing S2D operations. This functionality is implemented by features below:

$$S 2 D : [ N \times C \times H \times W ] \to [ N \times {CR}_{H} {R}_{W} \times H / {R}_{H} \times W / {R}_{W} ] {R}_{H} > {R}_{W}$$

Instead of the standard symmetric operation [N×C×H×W], an asymmetric S2D operation may be utilized where [N×CR_{H}R_{W}×H/R_{H}×W/R_{W}] for down-sampling. R_{H} may be considered a height rate factor and R_{W} may be considered a width rate factor (in which R_{H} is greater than R_{W}) such that by utilizing a smaller rate factor through division in the width dimension than in the other non-disparity dimension in this formula more features in the width disparity dimension are preserved. Therefore, at each stage of S2D down-sampling, dimensionality changes in rates of R_{H} and R_{W} may be utilized.

As can be seen with reference to FIG. 16, D2S up-sampling rates of R_{H} and R_{W} for up-sampling 1604 can also be implemented, according to aspects of the disclosure, as shown on the right-side of FIG. 16. These asymmetric operations include the use of asymmetric D2S operations in the disparity dimension, in which, a larger rate through multiplication in the width dimension is used than in other non-disparity dimensions. In particular, in order to gain more feature information in the width dimension, a larger rate “R” through multiplication in the width dimension is used than in the other non-disparity dimension when performing D2S operations for up-sampling. This functionality is implemented by features below:

$$D 2 S : [ N \times C \times H \times W ] \to [ N \times C / {R}_{H} {R}_{W} \times {HR}_{H} \times W {R}_{W} ] {R}_{H} < {R}_{W}$$

In this aspect, an asymmetric D2S operation is utilized where [N×C/R_{H}R_{W}×HR_{H}×W R_{W}]. R_{H} may be considered a height rate factor and R_{W} may be considered a width rate factor (in which R_{H} is less than R_{W}) such that by utilizing a larger rate factor through multiplication in the width dimension than in the other non-disparity dimension in this formula more features in the width disparity dimension are preserved.

With brief reference to FIG. 17, FIG. 17 illustrates a proof-of-concept of the techniques of the disclosure related to down-sampling for stereo depth estimation utilizing asymmetric operations in width and height to provide a stereo view of an image that preserves disparity and enhanced resolution, while still being performed in an efficient manner.

As has been described, processor 156 may operate to perform down-sampling/encoding functions and can implement ML functions for learning and/or inference. The encoding functions are based upon the asymmetric down-sizing operations for width and height of the image data captured by the cameras 132 and 134, as previously described, in which, the asymmetric operations include higher resolution in width. Based upon these implementation features during the down-sampling process by the processor 156, the stereo image output rendered by the up-sampling process is improved and includes stereo depth map resolution that closely replicates the original stereo depth map resolution associated with the original stereo image.

An example of the stereo depth map resolution can be seen with reference to FIG. 17. As can be seen in FIG. 17, in the upper-right, an image input of a man 1702 sitting at a table in front of kitchen with a plant 1704 in front of him is shown. The lower left image is a disparity map generated by a conventional process with down-sampling, in which height and width dimensions are equally weighted. The lower right is a disparity map generated by the previously described techniques to implement asymmetric operations for width and height of an image during down-sampling, in which, the asymmetric operations include higher resolution in width, in which, stereo vision is provided that preserves disparity and enhanced resolution, while still being performed in an efficient manner.

As can be seen in the lower right disparity map, performed with the previously described techniques of the disclosure, the disparity information is preserved. The disparity differences between the objects of the captured image—man 1702 sitting at the table in front of the kitchen with the plant 1704 in front of him—can be seen between the conventional process (left-hand side) and the previously described techniques of the disclosure (right-hand side), with few differences. However, by utilizing the previously described techniques of the disclosure, stereo vision is provided with preserved disparity and enhanced resolution, while being done more efficiently with less computational tasks and less power than the conventional process.

In particular, the quality of the lower right disparity map illustrates the improved features of the disclosure that utilize the previously described multi-aspect-ratio down-sizing implementation that focuses more on width than in height for stereo depth. As has been described, the disparity information per-pixel is carried by the stereo inputs and is then down-sampled/encoded, as previously described. Further, by utilizing an encoder that utilizes ML functionality, the disparity information may be implicitly carried and encoder functions may utilize ML in learning and/or inference.

In order to support high-resolution input, down-sampling aggressively in order to meet real-time and power consumption requirements is currently needed. Aspects of the previously described disclosure describe multi-aspect ratio techniques related to down-sampling for stereo depth estimation utilizing asymmetric operations in width and height, emphasizing width, to provide a stereo view that preserves disparity and enhanced resolution, while still being performed in an efficient manner. In one aspect, asymmetric down-sampling is implemented to better preserve disparity and to avoid low resolution in the width. Asymmetric super resolution may then be utilized to return desirable output as to the original input aspect ratio. For example, down-sampling may occur to as much as 32× in the height dimension, enabling a larger respective field, while keeping the disparity dimension down at 16× or even 8×. Further, disparity can be enhanced by allocating more computational power with asymmetric encoding and asymmetric super resolution.

As has been described, the previously described techniques for stereo depth estimation that utilize multi-aspect-ratio down-sizing implementations that focus more on width than in height for stereo depth (e.g., width-centric) results in pixel-wise disparities between rectified stereo images being processed in a manner that provides disparity preservation. Further, by the implementation of ML operations for learning and/or inference in encoding/down-sampling operations, stereo depth estimation for stereo images is further improved. In this way, down-sampling operations provide stereo vision of the image with improved disparity preservation. Also, by utilizing the previously described techniques of the disclosure, stereo vision is provided that preserves disparity and enhanced resolution, while being done in a more efficient computational manner by focusing more on width than height, which results in less computational tasks and less power than the conventional process. Therefore, as has been previously described in detail, an improved or modified stereo vision processing implementation has been described that utilizes an asymmetric down-sampling operation for the height and width of the object, in which, a higher resolution is in width.

It should be appreciated that the features previously described for down-sampling for stereo depth estimation utilizing asymmetric operations in width and height may be utilized for a wide variety of different devices 130. In particular, these type of digital video capabilities may be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Also, such devices may implemented in scenarios related to vehicles, mobile devices, security, etc.

Various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as limitations.

The various illustrative logical blocks, modules, and circuits described in connection with the aspects disclosed herein may be implemented or performed with a general purpose processor, a DSP, an ASIC, an FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various modifications to the described aspects may be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

The processes previously described may include additional aspects, such as any single aspect or any combination of aspects described below and/or in connection with one or more other processes described elsewhere herein.

Aspect 1: A device comprising: one or more memories configured to store one or more images including an object; a plurality of cameras configured to capture the one or more images including the object; and one or more processors coupled to the one or memories, the one or more processors configured to: based upon an object detected, determine a subset of cameras from the plurality of cameras to provide stereo vision of the object; and rotationally switch between a previously selected subset of cameras for a previous object to the determined subset of cameras for the object to provide stereo vision of the object.

Aspect 2: The device of aspect 1, further comprising a motion sensor to detect if the device is switched from a first orientation to second orientation.

Aspect 3: The device of aspect 2, wherein, the at least one processor is further configured to: switch to the subset of cameras from the plurality of cameras to provide stereo vision of the object based upon the switch detected by the motion sensor from the first orientation to the second orientation.

Aspect 4: The device of aspect 3, wherein the first orientation is a portrait orientation and the second orientation is a landscape orientation or the first orientation is a first slant orientation of cameras and the second orientation is a second slant orientation of cameras.

Aspect 5: The device of any aspects 1 through 4, wherein, the at least one processor is further configured to: combine multiple subsets of cameras from the plurality of cameras to provide stereo vision of the object.

Aspect 6: The device of any aspects 1 through 5, wherein, the at least one processor is further configured to: determine the subset of cameras from the plurality of cameras to provide stereo vision of the object based upon high frequency directional textures in determined directions.

Aspect 7: The device of aspect 1, wherein, asymmetric down-sampling operations for height and width are utilized to improve stereo vision.

Aspect 8: The device of aspect 1, wherein, factors to determine the subset of cameras from the plurality of cameras to provide stereo vision of an object include at least one of: image quality or directional high-frequency components.

Aspect 9: The device of aspect 1, wherein, the device is a mobile device for use by a user further comprising: a user interface to receive input from the user; a display to display objects to the user; an audio device to provide audio sound to the user; a transceiver to transmit and receive data; and the one or more processors are configured to: record an image of the object based on the selected subset of cameras.

Aspect 10: The device of aspect 9, wherein, the one or more processors are further configured to: determine an orientation of the device to provide stereo vision of the object; and recommend to the user the orientation of the device for the user to rotate the device to in order to obtain an image of the object.

Aspect 11: The device of aspect 10, wherein, the recommended orientation of the mobile device is at least one of: a portrait orientation, a landscape orientation, or a particular percentage orientation.

Aspect 12: The device of aspect 11, wherein, the recommendation to the user of the orientation of the device for the user to rotate the device to in order to obtain an image of the object by the one or more processors includes at least one of: the display device displaying a graphic indicator of the recommend orientation to the user; or the audio device providing an audio sound to the user of the recommended orientation.

Aspect 13: The device of any aspects 1 through 12, wherein, when the user selects the object, the object is recorded for the user based on the selected subset of cameras.

Aspect 14: The device of aspect 1, wherein, the device is a vehicle driving towards the object, the one or more processors are configured to: monitor the object for distance and collision avoidance based on the selected subset of cameras.

Aspect 15: The device of aspect 14, wherein, the at least one processor is further configured to: combine multiple subsets of cameras from the plurality of cameras to provide stereo vision of the object.

Aspect 16: The device of aspect 15, wherein, the at least one processor is further configured to: combine object data received from a camera of another vehicle to provide stereo vision of the object.

Aspect 17: The device any aspects 1 through 16, wherein, the object detected is selected based upon an object detection algorithm, and an asymmetric down-sampling operation for height and width is utilized to provide improved stereo vision of the object.

Aspect 18: The device of any aspects 1 through 17, further comprising a semantic label generator and a depth estimator, wherein the semantic label generator outputs a semantic label based upon an image captured by one or more of the cameras to the depth estimator, the depth estimator to utilize the semantic label to assist in stereo depth estimation for stereo vision.

Aspect 19: A method for providing stereo vision of an object, the method comprising: capturing one or more images including the object from a plurality of cameras; based upon an object detected, determine a subset of cameras from the plurality of cameras to provide stereo vision of the object; and rotationally switch between a previously selected subset of cameras for a previous object to the determined subset of cameras for the object to provide stereo vision of the object.

Aspect 20: A non-transitory computer-readable data storage medium having stored thereon instructions that, when executed, cause one or more processors to: capture one or more images including an object from a plurality of cameras; based upon an object detected, determine a subset of cameras from the plurality of cameras to provide stereo vision of the object; and rotationally switch between a previously selected subset of cameras for a previous object to the determined subset of cameras for the object to provide stereo vision of the object.

This disclosure describes one or more examples that may be applied independently or in a combined way. It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

One or more of the components, steps, features and/or functions illustrated in FIGS. 1-17 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-17 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Various examples have been described. These and other examples are within the scope of the following claims.

What is claimed is:

1. A device comprising:
one or more memories configured to store one or more images including an object;
a plurality of cameras configured to capture the one or more images including the object; and
one or more processors coupled to the one or memories, the one or more processors configured to:
based upon an object detected, determine a subset of cameras from the plurality of cameras to provide stereo vision of the object; and
rotationally switch between a previously selected subset of cameras for a previous object to the determined subset of cameras for the object to provide stereo vision of the object.

2. The device of claim 1, further comprising a motion sensor to detect if the device is switched from a first orientation to second orientation.

3. The device of claim 2, wherein, the at least one processor is further configured to: switch to the subset of cameras from the plurality of cameras to provide stereo vision of the object based upon the switch detected by the motion sensor from the first orientation to the second orientation.

4. The device of claim 3, wherein the first orientation is a portrait orientation and the second orientation is a landscape orientation or the first orientation is a first slant orientation of cameras and the second orientation is a second slant orientation of cameras.

5. The device of claim 1, wherein, the at least one processor is further configured to: combine multiple subsets of cameras from the plurality of cameras to provide stereo vision of the object.

6. The device of claim 1, wherein, the at least one processor is further configured to: determine the subset of cameras from the plurality of cameras to provide stereo vision of the object based upon high frequency directional textures in determined directions.

7. The device of claim 1, wherein, asymmetric down-sampling operations for height and width are utilized to improve stereo vision.

8. The device of claim 1, wherein, factors to determine the subset of cameras from the plurality of cameras to provide stereo vision of an object include at least one of: image quality or directional high-frequency components.

9. The device of claim 1, wherein, the device is a mobile device for use by a user further comprising:
a user interface to receive input from the user;
a display to display objects to the user;
an audio device to provide audio sound to the user;
a transceiver to transmit and receive data; and
the one or more processors are configured to:
record an image of the object based on the selected subset of cameras.

10. The device of claim 9, wherein, the one or more processors are further configured to:
determine an orientation of the device to provide stereo vision of the object; and
recommend to the user the orientation of the device for the user to rotate the device to in order to obtain an image of the object.

11. The device of claim 10, wherein, the recommended orientation of the mobile device is at least one of: a portrait orientation, a landscape orientation, or a particular percentage orientation.

12. The device of claim 11, wherein, the recommendation to the user of the orientation of the device for the user to rotate the device to in order to obtain an image of the object by the one or more processors includes at least one of: the display device displaying a graphic indicator of the recommend orientation to the user; or the audio device providing an audio sound to the user of the recommended orientation.

13. The device of claim 9, wherein, when the user selects the object, the object is recorded for the user based on the selected subset of cameras.

14. The device of claim 1, wherein, the device is a vehicle driving towards the object, the one or more processors are configured to: monitor the object for distance and collision avoidance based on the selected subset of cameras.

15. The device of claim 14 wherein, the at least one processor is further configured to: combine multiple subsets of cameras from the plurality of cameras to provide stereo vision of the object.

16. The device of claim 15, wherein, the at least one processor is further configured to: combine object data received from a camera of another vehicle to provide stereo vision of the object.

17. The device of claim 15, wherein, the object detected is selected based upon an object detection algorithm, and an asymmetric down-sampling operation for height and width is utilized to provide improved stereo vision of the object.

18. The device of claim 1, further comprising a semantic label generator and a depth estimator, wherein the semantic label generator outputs a semantic label based upon an image captured by one or more of the cameras to the depth estimator, the depth estimator to utilize the semantic label to assist in stereo depth estimation for stereo vision.

19. A method for providing stereo vision of an object, the method comprising:
capturing one or more images including the object from a plurality of cameras;
based upon an object detected, determine a subset of cameras from the plurality of cameras to provide stereo vision of the object; and
rotationally switch between a previously selected subset of cameras for a previous object to the determined subset of cameras for the object to provide stereo vision of the object.

20. A non-transitory computer-readable data storage medium having stored thereon instructions that, when executed, cause one or more processors to:
capture one or more images including an object from a plurality of cameras;
based upon an object detected, determine a subset of cameras from the plurality of cameras to provide stereo vision of the object; and
rotationally switch between a previously selected subset of cameras for a previous object to the determined subset of cameras for the object to provide stereo vision of the object.
